(19) United States
(12) Patent Application Publication
(10) Pub. No.: US 2024/0224088 A1
(43) Pub. Date: Jul. 4, 2024

(54) SYSTEMS, APPARATUSES, AND METHODS FOR NETWORK ANALYSIS

(71) Applicant: Assurant, Inc., New York, NY (US)

(72) Inventors: Mircea Ionescu, Westlake, OH (US); Craig Thole, Philadelphia, PA (US); Ben Jakuben, Mentor, OH (US)

(21) Appl. No.: 18/091,908

(22) Filed: Dec. 30, 2022

(51) Int. Cl. H04W 24/08; H04M 3/22

(52) U.S. Cl. CPC H04W 24/08; H04M 3/2218

(57) ABSTRACT

Embodiments of the present disclosure provided herein include systems, apparatuses, and methods for network analysis. In various embodiments, a network may include an area wide network and a plurality of user electronic devices. Example embodiments of network analysis include area wide network analysis, user electronic device analysis, and troubleshooting and diagnostics associated with the area wide network and the user electronic devices. In various embodiments the network analysis may be based on network event or a fault.

### TECHNOLOGICAL FIELD

Example embodiments of the present disclosure related generally to area wide network analysis, user electronic device analysis, and troubleshooting and diagnostics associated with the same.

### BACKGROUND

Electronic devices communicating over one or more networks with remote devices and systems may experience a variety of faults, including transmission issues. To protect the privacy of the user of the electronic devices, the content of the electronic device communications (e.g., voice signals from a call) may be protected, such as by encryption or otherwise by shielding the content from access by devices and parties not intended to receive the content. Such protections, while invaluable for protecting user privacy, limit the ability of third parties, such as carriers, service providers, utility operators, and the like, to gather sufficient information to troubleshoot electronic device communication faults. Applicant has identified a number of deficiencies and problems associated with present systems, methods, and computer program products for analyzing networks. Through applied effort, ingenuity, and innovation, many of these identified problems have been solved by developing solutions that are included in embodiments of the present disclosure, many examples of which are described in detail herein.

### BRIEF SUMMARY

Various embodiments described herein relate to systems, apparatuses, and methods for network analysis utilizing one or more user devices connected to the network.

In accordance with a first aspect of the disclosure, a first method is provided. In some embodiments, the first method comprises: receiving, at a device information system from a first user device, a user device data object; wherein the user device data object comprises user device data associated with a network event; wherein the network event comprises at least one transmission between the first user device and a second device over a network; calculating, based on the user device data, a performance rating associated with the at least one transmission, wherein the performance rating is indicative of a quality of the at least one transmission; generating a first summary data object based on the performance rating, wherein the first summary data object comprises renderable data indicative of the quality of the at least one transmission.

In some embodiments of the first method, generating the first summary data object comprises diagnosing a fault with the first user device based on the performance rating, wherein the performance rating is below a threshold value.

In some embodiments, the first method further comprises: receiving, at the device information system from a plurality of additional user devices, additional user device data objects, the additional user device data objects comprising additional user device data; and either: (1) comparing the additional user device data associated with the plurality of additional user devices with the user device data associated with the first user device; or (2) calculating, based on the additional user device data, an additional performance rating for each of the plurality of additional user devices and comparing the additional performance ratings for the plurality of additional user devices with the performance rating for the first user device; and diagnosing a fault with the first user device or the network based on the comparison of (1) or (2), wherein the renderable data indicative of the quality of the at least one transmission comprises renderable data indicative of the fault.

In some embodiments of the first method, the first method further comprises: receiving, at the device information system from a plurality of additional user devices, additional user device data objects; comparing at least a portion of the user device data object with at least a portion of the additional user device data objects; and diagnosing a fault with the first user device or the network based on the comparison, wherein the renderable data indicative of the quality of the at least one transmission comprises renderable data indicative of the fault.

In some embodiments of the first method, the portion of the user device data object and the portion of the additional user device data objects comprises one or more of location data, tower identification data, or call type data.

In some embodiments of the first method, the first method further comprises: aggregating at least a portion of the additional user device data objects to generate an aggregated user device data object; and generating a model based on the aggregated user device data object, wherein comparing at least a portion of the user device data object with at least a portion of the additional user device data objects comprises applying the portion of the user device data object to the model.

In some embodiments of the first method, the user device data comprises indirect data associated with the quality of the at least one transmission, and wherein the indirect data comprises data that does not include user communication content, such that the performance rating comprises an estimation of the quality without using the user communication content.

In some embodiments of the first method, the network event comprises a call between the first user device and the second device, wherein the user device data comprises user device data associated with the call, wherein the performance rating comprises a call performance rating associated with the call, and wherein the quality of the at least one transmission comprises a call quality.

In some embodiments of the first method, the user device data comprises indirect data associated with the call quality, and wherein the indirect data comprises data that does not include user communication content, such that the call performance rating comprises an estimation of the call quality without using the user communication content including voice signals.

In some embodiments of the first method, the first method further comprises: causing rendering of a graphical user interface element on the first user device, wherein the graphical user interface element comprises a permission request, and receiving a selection indication associated with the graphical user interface element of acceptance of the permission request, wherein the user device data object is received in an instance in which the permission request is accepted.

In some embodiments of the first method, the user device data object comprises user device data associated with one or more state changes associated with the at least one transmission, the user device data comprising data associated with the plurality of state changes.

In some embodiments of the first method, calculating the performance rating comprises: identifying the one or more state changes of the user device, including a terminal state change; determining, based on the one or more state changes and the data associated with each of the one or more state changes, the performance rating.

In some embodiments of the first method, the user device data comprises data indicative of one or more of signal strength associated with the at least one transmission, transmission latency associated with the at least one transmission, or a termination identifier associated with the at least one transmission.

In some embodiments of the first method, the first method further comprises: querying a second user device for a second user device data object; receiving, from the second user device, the second user device data object; determining a confidence level based on the first user device data object or the performance rating and based on the second user device data object; and in an instance in which the confidence level is above a threshold, the first summary data object comprises a fault summary associated with a fault.

In some embodiments of the first method, the determination of the confidence level is based at least on tower identification data, location data, and signal strength data from each of the first user device data object and the second user device data object.

In some embodiments of the first method, a model of the first user device is different from a model of the second user device.

In some embodiments of the first method, querying the second user device further comprises: determining a location of the first user device; filtering the location of each of a plurality of user devices for one or more of the plurality of user devices with location data within a threshold distance of the location of the first user device; identifying the second user device for querying from the one or more of the plurality of user devices with location data within a threshold distance of the location of the first user device.

In some embodiments of the first method, the first network device and the second network device are wirelessly connected to a same network tower.

In some embodiments of the first method, the user device data object comprises historical user device data and current user device data.

In some embodiments of the first method, the first summary data object comprises an indication of health of one or more network towers.

In some embodiments of the first method, the performance rating is associated with a confidence level.

In some embodiments of the first method, the user device data comprises metric data.

In accordance with a second aspect of the disclosure, a first system is provided. In some embodiments, the first system comprises: a device information system connected to a plurality of user devices via a network, wherein device information system is configured to: receive, from a first user device, a user device data object; wherein the user device data object comprises user device data associated with a network event; wherein the network event comprises at least one transmission between the first user device and a second device over a network; calculate, based on the user device data, a performance rating associated with the at least one transmission, wherein the performance rating is indicative of a quality of the at least one transmission; generate a first summary data object based on the performance rating, wherein the first summary data object comprises renderable data indicative of the quality of the at least one transmission.

In some embodiments of the first system, to generate the first summary data object comprises a diagnosis of a fault with the first user device based on the performance rating, wherein the performance rating is below a threshold value.

In some embodiments of the first system, the device information system is further configured to: receive, from a plurality of additional user devices, additional user device data objects, the additional user device data objects comprising additional user device data; and either: (1) compare the additional user device data associated with the plurality of additional user devices with the user device data associated with the first user device; or (2) calculate, based on the additional user device data, an additional performance rating for each of the plurality of additional user devices and comparing the additional performance ratings for the plurality of additional user devices with the performance rating for the first user device; and diagnose a fault with the first user device or the network based on the comparison of (1) or (2), wherein the renderable data indicative of the quality of the at least one transmission comprises renderable data indicative of the fault.

In some embodiments of the first system, the device information system is further configured to: receive, from a plurality of additional user devices, additional user device data objects; compare at least a portion of the user device data object with at least a portion of the additional user device data objects; and diagnose a fault with the first user device or the network based on the comparison, wherein the renderable data indicative of the quality of the at least one transmission comprises renderable data indicative of the fault.

In some embodiments of the first system, the portion of the user device data object and the portion of the additional user device data objects comprises one or more of location data, tower identification data, or call type data.

In some embodiments of the first system, the device information system is further configured to: aggregate at least a portion of the additional user device data objects to generate an aggregated user device data object; and generate a model based on the aggregated user device data object, wherein comparing at least a portion of the user device data object with at least a portion of the additional user device data objects comprises applying the portion of the user device data object to the model.

In some embodiments of the first system, the user device data comprises indirect data associated with the quality of the at least one transmission, and wherein the indirect data comprises data that does not include user communication content, such that the performance rating comprises an estimation of the quality without using the user communication content.

In some embodiments of the first system, the network event comprises a call between the first user device and the second device, wherein the user device data comprises user device data associated with the call, wherein the performance rating comprises a call performance rating associated with the call, and wherein the quality of the at least one transmission comprises a call quality.

In some embodiments of the first system, the user device data comprises indirect data associated with the call quality, and wherein the indirect data comprises data that does not include user communication content, such that the call performance rating comprises an estimation of the call quality without using the user communication content including voice signals.

In some embodiments of the first system, the device information system is further configured to: cause rendering of a graphical user interface element on the first user device, wherein the graphical user interface element comprises a permission request, and receive a selection indication associated with the graphical user interface element of acceptance of the permission request, wherein the user device data object is received in an instance in which the permission request is accepted.

In some embodiments of the first system, the user device data object comprises user device data associated with one or more state changes associated with the at least one transmission, the user device data comprising data associated with the plurality of state changes.

In some embodiments of the first system, to calculate the performance rating comprises: identify the one or more state changes of the user device, including a terminal state change; determine, based on the one or more state changes and the data associated with each of the one or more state changes, the performance rating.

In some embodiments of the first system, the user device data comprises data indicative of one or more of signal strength associated with the at least one transmission, transmission latency associated with the at least one transmission, or a termination identifier associated with the at least one transmission.

In some embodiments of the first system, the device information system is further configured to: query a second user device for a second user device data object; receive, from the second user device, the second user device data object; determine a confidence level based on the first user device data object or the performance rating and based on the second user device data object; and in an instance in which the confidence level is above a threshold, the first summary data object comprises a fault summary associated with a fault.

In some embodiments of the first system, the determination of the confidence level is based at least on tower identification data, location data, and signal strength data from each of the first user device data object and the second user device data object.

In some embodiments of the first system, a model of the first user device is different from a model of the second user device.

In some embodiments of the first system, to query the second user device further comprises: determine a location of the first user device; filter the location of each of a plurality of user devices for one or more of the plurality of user devices with location data within a threshold distance of the location of the first user device; identify the second user device for querying from the one or more of the plurality of user devices with location data within a threshold distance of the location of the first user device.

In some embodiments of the first system, the first network device and the second network device are wirelessly connected to a same network tower.

In some embodiments of the first system, the user device data object comprises historical user device data and current user device data.

In some embodiments of the first system, the first summary data object comprises an indication of health of one or more network towers.

In some embodiments of the first system, the performance rating is associated with a confidence level.

In some embodiments of the first system, the user device data comprises metric data.

In accordance with a third aspect of the disclosure, a second method is provided. In some embodiments, the second method comprises: detecting, via a software application operating on a first user device, initiation of a network event, the network event comprising at least one transmission between the first user device and a second device over a network; collecting, via the software application, user device data associated with the network event during the network event, wherein the user device data is indicative of a performance rating associated with a quality of the at least one transmission; generating a user device data object comprising the user device data associated with the network event; and transmitting the user device data object to a device information system.

In some embodiments of the second method, the second method further comprises: calculating, based on the user device data, the performance rating associated with the at least one transmission, wherein the performance rating is indicative of a quality of the at least one transmission; and diagnosing a fault with the first user device based on the performance rating, wherein the performance rating is below a threshold value.

In some embodiments of the second method, the user device data comprises indirect data associated with a quality of the at least one transmission, and wherein the indirect data comprises data that does not include user communication content.

In some embodiments of the second method, the network event comprises a call between the first user device and the second device, wherein the user device data comprises user device data associated with the call.

In some embodiments of the second method, the user device data comprises indirect data associated with a call quality, and wherein the indirect data comprises data that does not include user communication content including voice signals.

In some embodiments of the second method, the second method further comprises: rendering of a graphical user interface element on the first user device, wherein the graphical user interface element comprises a permission request; and receiving a selection indication associated with the graphical user interface element of acceptance of the permission request, wherein the user device data object is generated in an instance in which the permission request is accepted.

In some embodiments of the second method, the permission request comprises a request for enhanced permissions for the software application.

In some embodiments of the second method, the user device data object comprises user device data associated with one or more state changes associated with the at least one transmission, including a terminal state change, and wherein collecting the user device data comprises collecting user device data associated with the plurality of state changes.

In some embodiments of the second method, collecting the user device data comprises collecting data indicative of one or more of signal strength associated with the at least one transmission, transmission latency associated with the at least one transmission, or a termination identifier associated with the at least one transmission.

In some embodiments of the second method, the software application is triggered to collect the user device data by the first user device upon initiation of the network event.

In some embodiments of the second method, the software application is triggered to collect at least a portion of the user device data upon the occurrence of each of a plurality of state changes of the first user device.

In some embodiments of the second method, the user device data object is indicative of a health of one or more network towers associated with the network.

In some embodiments of the second method, the second method further comprises: determining a confidence level based on the user device data object.

In some embodiments of the second method, the user device data comprises metric data.

In some embodiments of the second method, transmitting the user device data object to the device information system comprises transmitting the user device data object to the device information system following termination of the network event.

In accordance with a fourth aspect of the disclosure, a first apparatus is provided. In some embodiments of the first apparatus, the first apparatus comprises at least one processor and at least one memory including computer program code, the at least one memory and the computer program code configured to, with the at least one processor, cause the apparatus to: detect initiation of a network event, the network event comprising at least one transmission between the first user device and a second device over a network; collect user device data associated with the network event during the network event, wherein the user device data is indicative of a performance rating associated with a quality of the at least one transmission; generate a user device data object comprising the user device data associated with the network event; and transmit the user device data object to a device information system.

In some embodiments of the first apparatus, the at least one memory and the computer program code configured to, with the at least one processor, further cause the apparatus to: calculate, based on the user device data, the performance rating associated with the at least one transmission, wherein the performance rating is indicative of a quality of the at least one transmission; and diagnose a fault with the first user device based on the performance rating, wherein the performance rating is below a threshold value.

In some embodiments of the first apparatus, the user device data comprises indirect data associated with a quality of the at least one transmission, and wherein the indirect data comprises data that does not include user communication content.

In some embodiments of the first apparatus, the network event comprises a call between the first user device and the second device, wherein the user device data comprises user device data associated with the call.

In some embodiments of the first apparatus, the user device data comprises indirect data associated with a call quality, and wherein the indirect data comprises data that does not include user communication content including voice signals.

In some embodiments of the first apparatus, the at least one memory and the computer program code configured to, with the at least one processor, further cause the apparatus to: render a graphical user interface element on the first user device, wherein the graphical user interface element comprises a permission request; and receive a selection indication associated with the graphical user interface element of acceptance of the permission request, wherein the user device data object is generated in an instance in which the permission request is accepted.

In some embodiments of the first apparatus, the permission request comprises a request for enhanced permissions for the software application.

In some embodiments of the first apparatus, the user device data object comprises user device data associated with one or more state changes associated with the at least one transmission, including a terminal state change, and wherein collecting the user device data comprises collecting user device data associated with the plurality of state changes.

In some embodiments of the first apparatus, to collect the user device data comprises to collect data indicative of one or more of signal strength associated with the at least one transmission, transmission latency associated with the at least one transmission, or a termination identifier associated with the at least one transmission.

In some embodiments of the first apparatus, to collect the user device data is triggered by the first user device upon initiation of the network event.

In some embodiments of the first apparatus, to collect at least a portion of the user device data is triggered upon the occurrence of each of a plurality of state changes of the first user device.

In some embodiments of the first apparatus, the user device data object is indicative of a health of one or more network towers associated with the network.

In some embodiments of the first apparatus, the at least one memory and the computer program code configured to, with the at least one processor, further cause the apparatus to: determine a confidence level based on the user device data object.

In some embodiments of the first apparatus, the user device data comprises metric data.

In some embodiments of the first apparatus, to transmit the user device data object to the device information system comprises transmission of the user device data object to the device information system following termination of the network event.

In accordance with a fifth aspect of the disclosure, a third method is provided. In some embodiments of the third method, the third method comprises: receiving, at a device information system from a first user device, a user device data object comprising user device data; determining at least one fault based on the user device data object comprising: identifying one or more state changes of the user device based on the user device data object, including a terminal state change; determining, based on the one or more state changes and the user device data associated with each of the one or more state changes, an indication of the at least one fault; and generating a first network summary data object based on the indication of the fault, wherein the first network summary data object includes the indication of the fault.

In some embodiments of third method, the indication of the least one fault comprises a fault with the first user device or the network.

In some embodiments of third method, the third method further comprises: filtering data in the user device data object for user device data associated with each of the one or more state changes, wherein user data associated with each of the one or more state changes includes location data, tower identification data, and signal strength data.

In some embodiments of third method, the user device data associated with each of the one or more state changes comprises indirect data associated with a quality of at least one transmission associated with the one or more state changes, and wherein the indirect data comprises data that does not include user communication content.

In some embodiments of third method, the at least one transmission is a call made by the first user device, and wherein the indirect data excludes voice signals.

In some embodiments of third method, receiving the user device data object occurs in real-time following generation of the user device data object by the first user device.

In some embodiments of third method, receiving the user device data object occurs following the terminal state change.

In some embodiments of third method, the determining the indication of the at least one fault is further based on a make and model of the user device.

In some embodiments of third method, receiving the user device data object is based on a transmission from the user device based on a trigger, wherein the trigger is based on a last change state.

In some embodiments of third method, the indication of the at least one fault is further based on confidence level exceeding a confidence threshold associated with the indication of the at least one fault.

In some embodiments of third method, the third method further comprises: transmitting the first summary data object to a network information system.

In some embodiments of third method, the transmitting the first network summary data object to a network information system is transmitted based on a schedule.

In some embodiments of third method, the third method further comprises: receiving, at the device information system from a plurality of additional user devices, additional user device data objects; aggregating, prior to determining the indication of the at least one fault based on the user device data object, the user device data from received from the first user device and the additional user device data objects from the plurality of additional user devices to generate an aggregated user device data object; and wherein the determining the indication of the at least one fault is further based on the aggregated user device data object.

In some embodiments of third method, the determining the indication of the at least one fault comprises identifying a network-specific fault based on a determination that one or more of the plurality of additional user devices has experiences a fault corresponding to the at least one fault.

In some embodiments of third method, the third method further comprises: identifying the network-specific fault based on one or more of location data, tower identification data, or call type data.

In some embodiments of third method, determining the indication of the at least one fault is further based on a latency determination associated with one or more of the state changes.

In some embodiments of third method, the determining the indication of the at least one fault is further based on a performance rating of a call associated with the one or more state changes, wherein the performance rating is associated with call quality.

In some embodiments of third method, the performance rating associated with call quality is determined based on at least signal strength associated with the call.

In some embodiments of third method, the third method further comprises: receiving a plurality of additional user device data objects from a plurality of additional user devices wirelessly connected to a network via at least one network tower, wherein the first user device is wirelessly connected to the network via the at least one network tower; determining, based on the received user device data object and additional user device data objects, an indication of a network-specific fault; and wherein the first network summary data object is based on the indication of the network-specific fault.

In some embodiments of third method, the user device data object comprises an indication of a first fault associated with the first user device, and wherein the indication of the at least one fault is a network-specific fault determined based on the indication of the first fault.

In some embodiments of third method, the third method further comprises: receiving a plurality of additional user device data objects associated with a plurality of additional user devices, wherein the plurality of additional user device data objects comprise an indication of one or more faults, and wherein the network-specific fault determined based on the indication of the first fault and the indication of the one or more faults.

In some embodiments of third method, the indication of the first fault comprises an indication of a dropped call.

In accordance with a sixth aspect of the disclosure, a second system is provided. In some embodiments of the second system, the second system comprises: a device information system connected to a plurality of user devices via a network, wherein the device information system is configured to: receive, from a first user device, a user device data object comprising user device data; determine at least one fault based on the user device data object comprising: identify one or more state changes of the user device based on the user device data object, including a terminal state change; determine, based on the one or more state changes and the user device data associated with each of the one or more state changes, an indication of the at least one fault; and generate a first network summary data object based on the indication of the fault, wherein the first network summary data object includes the indication of the fault.

In some embodiments of the second system, the indication of the at least one fault comprises a fault with the first user device or the network.

In some embodiments of the second system, the device information system is further configured to: filter data in the user device data object for user device data associated with each of the one or more state changes, wherein user data associated with each of the one or more state changes includes location data, tower identification data, and signal strength data.

In some embodiments of the second system, the user device data associated with each of the one or more state changes comprises indirect data associated with a quality of at least one transmission associated with the one or more state changes, and wherein the indirect data comprises data that does not include user communication content.

In some embodiments of the second system, the at least one transmission is a call made by the first user device, and wherein the indirect data excludes voice signals.

In some embodiments of the second system, the user device data object is received in real-time following generation of the user device data object by the first user device.

In some embodiments of the second system, the user device data object is received following the terminal state change.

In some embodiments of the second system, to determine the indication of the at least one fault is further based on a make and model of the user device.

In some embodiments of the second system, to receive the user device data object is based on a transmission from the user device based on a trigger, wherein the trigger is based on a last change state.

In some embodiments of the second system, the indication of the at least one fault is further based on confidence level exceeding a confidence threshold associated with the indication of the at least one fault.

In some embodiments of the second system, the device information system is further configured to: transmit the network summary data object to a network information system.

In some embodiments of the second system, to transmit the first network summary data object to the network information system is based on a schedule.

In some embodiments of the second system, the device information system is further configured to: receive, from a plurality of additional user devices, additional user device data objects; aggregate, prior to determining the indication of the at least one fault based on the user device data object, the user device data from received from the first user device and the additional user device data objects from the plurality of additional user devices to generate an aggregated user device data object; and wherein to determine the indication of the at least one fault is further based on the aggregated user device data object.

In some embodiments of the second system, to determine the indication of the at least one fault comprises: identify a network-specific fault based on a determination that one or more of the plurality of additional user devices has experiences a fault corresponding to the at least one fault.

In some embodiments of the second system, the device information system is further configured to: identify the network-specific fault based on one or more of location data, tower identification data, or call type data.

In some embodiments of the second system, to determine the indication of the at least one fault is further based on a latency determination associated with one or more of the state changes.

In some embodiments of the second system, to determine the indication of the at least one fault is further based on a performance rating of a call associated with the one or more state changes, wherein the performance rating is associated with call quality.

In some embodiments of the second system, the performance rating associated with call quality is determined based on at least signal strength associated with the call.

In some embodiments of the second system, the device information system is further configured to: receive a plurality of additional user device data objects from a plurality of additional user devices wirelessly connected to a network via at least one network tower, wherein the first user device is wirelessly connected to the network via the at least one network tower; determine, based on the received user device data object and additional user device data objects, an indication of a network-specific fault; and wherein the first network summary data object is based on the indication of the network-specific fault.

In some embodiments of the second system, the user device data object comprises an indication of a first fault associated with the first user device, and wherein the indication of the at least one fault is a network-specific fault determined based on the indication of the first fault.

In some embodiments of the second system, the device information system is further configured to: receive a plurality of additional user device data objects associated with a plurality of additional user devices, wherein the plurality of additional user device data objects comprise an indication of one or more faults, and wherein the network-specific fault determined based on the indication of the first fault and the indication of the one or more faults.

In some embodiments of the second system, the indication of the first fault comprises an indication of a dropped call.

In accordance with a seventh aspect of the disclosure, a third system is provided. In some embodiments of the third system, the third system comprises: a device information system connected to a plurality of user devices via a network, wherein the plurality of devices are connected to the network via at least one network access point, wherein the device information system is configured to: receive, from each of the plurality of user devices, a user device data object associated with at least one network event associated with each of the plurality of user devices, the at least one network events occurring via the at least one network access point; determine, based on the received user device data objects, an indication of a network-specific fault; generate a fault summary based on the indication of the network-specific fault and the received user device data objects.

In some embodiments of the third system, the device information system is further configured to: generate a network data object contemporaneously with the generation of the fault summary; and transmit, along with the fault summary, the network data object to a network information system.

In some embodiments of the third system, to generate the network data object comprises: classify data in the received user device data objects; and filter the classified data to remove data in the received user device data objects not associated with the network-specific fault.

In some embodiments of the third system, the network data object includes network access point identification data, user device location data, and user device signal strength data.

In some embodiments of the third system, the indication of a network-specific fault is determined based on a machine learning model.

In some embodiments of the third system, the at least one network access point comprises a first network access point, wherein the system is configured to: generate a machine learning training data set based on the user device data objects from the plurality of user devices associated with the first network access point; train the machine learning model based on the machine learning training data set; receive a first user device data object from a first user device connected to the network via the first network access point; and determine an indication of a fault by applying the first user device data object to the machine learning model.

In some embodiments of the third system, the fault comprises one of a device-specific fault and the network-specific fault.

In some embodiments of the third system is further configured to generate a machine learning model for each network access point of a plurality of network access points.

In some embodiments of the third system, the machine learning model is configured to determine the indication of the fault based on a calculated quality associated with a network event affecting the first user device.

In some embodiments of the third system, the indication of the network-specific fault comprises an indication of a determination of a failure associated with an access point of the at least one network access point.

In some embodiments of the third system, the indication of a network-specific fault comprises an indication of a dropped call at one or more of the plurality of user devices.

In some embodiments of the third system, the user device data objects comprise an indication of one or more faults associated with one or more of the plurality of user devices, and wherein the network-specific fault determined based on the indication of the one or more faults.

In some embodiments of the third system, the indication of one or more faults associated with one or more of the plurality of user devices includes a first fault, wherein the first fault comprises an indication of a dropped call.

In some embodiments of the third system, the at least one network access point comprises at least one cellular tower.

In accordance with a eighth aspect of the disclosure, a fourth method is provided. In some embodiments of the fourth method, the fourth method comprises: providing a device information system connected to a plurality of user devices via a network, wherein the plurality of devices are connected to the network via at least one network access point, wherein the device information system is configured to: receiving, from each of the plurality of user devices, a user device data object associated with at least one network event associated with each of the plurality of user devices, the at least one network events occurring via the at least one network access point; determining, based on the received user device data objects, an indication of a network-specific fault; generating a fault summary based on the indication of the network-specific fault and the received user device data objects.

In some embodiments of the fourth method, the fourth method further comprises: generating a network data object contemporaneously with the generation of the fault summary; and transmitting, along with the fault summary, the network data object to a network information system.

In some embodiments of the fourth method, generating the network data object comprises: classifying data in the received user device data objects; and filtering the classified data to remove data in the received user device data objects not associated with the network-specific fault.

In some embodiments of the fourth method, the network data object includes network access point identification data, user device location data, and user device signal strength data.

In some embodiments of the fourth method, the indication of a network-specific fault is determined based on a machine learning model.

In some embodiments of the fourth method, the at least one network access point comprises a first network access point, and wherein the method further comprises: generating a machine learning training data set based on the user device data objects from the plurality of user devices associated with the first network access point; training the machine learning model based on the machine learning training data set; receiving a first user device data object from a first user device connected to the network via the first network access point; and determining an indication of a fault by applying the first user device data object to the machine learning model.

In some embodiments of the fourth method, the fault comprises one of a device-specific fault and the network-specific fault.

In some embodiments of the fourth method, the fourth method further comprises: generating a machine learning model for each network access point of a plurality of network access points.

In some embodiments of the fourth method, the machine learning model is configured to determine the indication of the fault based on a calculated quality associated with a network event affecting the first user device.

In some embodiments of the fourth method, the indication of the network-specific fault comprises an indication of a determination of a failure associated with an access point of the at least one network access point.

In some embodiments of the fourth method, the indication of a network-specific fault comprises an indication of a dropped call at one or more of the plurality of user devices.

In some embodiments of the fourth method, the user device data objects comprise an indication of one or more faults associated with one or more of the plurality of user devices, and wherein the network-specific fault determined based on the indication of the one or more faults.

In some embodiments of the fourth method, the indication of one or more faults associated with one or more of the plurality of user devices includes a first fault, wherein the first fault comprises an indication of a dropped call.

In some embodiments of the fourth method, the at least one network access point comprises at least one cellular tower.

In accordance with a ninth aspect of the disclosure, a fourth system is provided. In some embodiments of the fourth system, the fourth system comprises: a device information system connected to a plurality of user devices via a network, wherein the plurality of user devices are connected to one or more network access points, wherein the device information system is configured to: receive, from each of the plurality of user devices, a user device data object; determine, based on the received user device data objects, an indication of health of the one or more network access points; generate a network health summary based on the indication of health and the received user device data objects; and transmit, to a network information system, the network health summary.

In some embodiments of the fourth system, the indication of health of one or more network access points is based on performance ratings calculated based on the user device data objects for the plurality of user devices.

In some embodiments of the fourth system, the user device data objects comprise historical user device data and current user device data; and wherein the determination of the indication of network health is further based on both the historical user device data and the current user device data.

In some embodiments of the fourth system, the indication of health is associated with a confidence level.

In some embodiments of the fourth system, the user device data objects comprise an indication of one or more faults associated with one or more of the plurality of user devices, and wherein the network-specific fault determined based on the indication of the one or more faults.

In some embodiments of the fourth system, the indication of one or more faults associated with one or more of the plurality of user devices includes a first fault, wherein the first fault comprises an indication of a dropped call.

In some embodiments of the fourth system, the at least one or more network access points comprise at least one cellular tower.

In accordance with a tenth aspect of the disclosure, a fifth method is provided. In some embodiments of the fifth method, the fifth method comprises: providing a device information system connected to a plurality of user devices via a network, wherein the plurality of user devices are connected to one or more network access points: receiving, at the device information system and from each of the plurality of user devices, a user device data object; determining, based on the received user device data objects, an indication of health of the one or more network access points; generating a network health summary based on the indication of health and the received user device data objects; and transmitting, to a network information system from the device information system, the network health summary.

In some embodiments of the fifth method, the indication of health of one or more network access points is based on performance ratings calculated based on the user device data objects for the plurality of user devices.

In some embodiments of the fifth method, the user device data objects comprise historical user device data and current user device data; and wherein the determination of the indication of network health is further based on both the historical user device data and the current user device data.

In some embodiments of the fifth method, the indication of health is associated with a confidence level.

In some embodiments of the fifth method, the user device data objects comprise an indication of one or more faults associated with one or more of the plurality of user devices, and wherein the network-specific fault determined based on the indication of the one or more faults.

In some embodiments of the fifth method, the indication of one or more faults associated with one or more of the plurality of user devices includes a first fault, wherein the first fault comprises an indication of a dropped call.

In some embodiments of the fifth method, the at least one or more network access points comprise at least one cellular tower.

### BRIEF SUMMARY OF THE DRAWINGS

Having thus described certain example embodiments of the present disclosure in general terms, reference will now be made to the accompanying drawings, which are not necessarily drawn to scale, and wherein:

FIG. 1 illustrates an example of a network environment within which embodiments of the present disclosure may operate;

FIG. 2 illustrates a block diagram of a user device in accordance with one or more embodiments of the present disclosure;

FIG. 3 illustrates a block diagram of an information system with one or more embodiments of the present disclosure;

FIG. 4 illustrates a flowchart according to an example method performed by a user device to generate and transmit user device data;

FIG. 5 illustrates a flowchart according to an example method for generating a fault summary;

FIG. 6 illustrates a flowchart according to an example method for generating a fault indication based on historical user device data;

FIG. 7 illustrates a flowchart according to an example method for generating a network health summary;

FIG. 8 illustrates a flowchart according to an example method for generating an indication of a network-specific fault or user device-specific fault;

FIG. 9 illustrates a flowchart according to an example method for calculating a performance rating and generating a summary data object associated with a network event; and

FIG. 10 illustrates a flowchart according to an example method for generating user device data associated with a network event.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

### Overview

Some example embodiments of the present disclosure will now be described more fully hereinafter with reference to the accompanying drawings, in which some, but not all, embodiments of the invention are shown. Like reference numerals refer to like elements throughout. Indeed, various embodiments of the present disclosure may be embodied in many different forms and should not be construed as limited to the embodiments set forth herein. Rather, these embodiments are provided so that this disclosure will satisfy applicable legal requirements.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment or preclude different features, structures, or characteristics from being included in the same and/or different embodiments.

As used herein, the word “example” or “exemplary” is used herein to mean “serving as an example, instance, or illustration.” Any implementation described herein as “example” or “exemplary” is not necessarily to be construed as preferred or advantageous over other implementations. As used herein, the term “or” is used in both the alternative and conjunctive sense, unless otherwise indicated.

The figures are not drawn to scale and are provided merely to illustrate some example embodiments of the inventions described herein. The figures do not limit the scope of the present disclosure or the appended claims. Several aspects of the example embodiments are described below with reference to example applications for illustration. It should be understood that numerous specific details, relationships, and methods are set forth to provide a full understanding of the example embodiments. One having ordinary skill in the relevant art, however, will readily recognize that the example embodiments can be practiced without one or more of the specific details or with other methods. In other instances, well-known structures and/or operations are not shown in detail to avoid obscuring the example embodiments.

Various embodiments of the present invention are directed to improved systems, apparatuses, and methods for network analysis using one or more user devices, which may be mobile electronic devices. The use of mobile electronic devices continues to expand as does the complexity of hardware technology and software applications allowing these mobile electronic devices to connect to and interact through networks. Users utilize networks (e.g., 5G networks, LTE networks, GSM networks, Wi-Fi networks, etc.) to connect with each other. These networks allow users to make voice calls, video calls, stream data, and otherwise transmit and receive signals. Administering such networks and devices requires addressing technical problems not only with the network infrastructure but also with the multitude of user devices operating on the network, which is only increasing as more and different types of user devices are operating on these networks. Further, even among user devices of the same make, model, and version, a user of a user device may run distinct software applications (e.g., apps) on their own user device, each of which may place different demands on the user device and the network. Network operators may have limited insights and/or ability to directly measure a user's experience and how a network may be operating. Thus, there is a growing need for maintaining high quality service, rapidly identifying network performance issues and/or faults, and proactively identifying network and user device performance problems and/or faults for troubleshooting. In various embodiments, network operators may access data from network infrastructure but may fail to understand network performance as experienced by a user on their user device.

Improvements provided by some of the embodiments described herein may include analysis of a network from the perspective of a user, such as via a user device. Traditionally network analysis may rely on network data without accounting for the user experience, which misses technical indicators that may be determined, directly or indirectly, from user device data, and which may fail to account for or predict the observable quality of the network experience for the user. The present invention may use data from one or more user devices to analyze how each is experiencing the network, including the performance of the device and any faults the user device may experience. The experience of a user may be determined either directly or indirectly, which may or may not depend on one or more permissions that a user may have granted. In some embodiments discussed herein, the calculations associated with the user experience may protect user privacy and the content of user communications while determining a proxy for the quality of the user communications based on accessible, non-private data or data for which a user has granted permission to access. Moreover, performance issues and/or faults experienced by a user may or may not be network-specific or user device-specific.

There may be various makes and models of user devices on the network, and each user device may be running a various mixture of different applications creating an environment where a user device may experience different levels of performance and/or faults. To a user, their experiences may not be readily differentiated between when poor performance or a fault that is network-specific or user device-specific. Thus being able to identify and troubleshoot network-specific and user device-specific performance and/or faults lead to improvements in troubleshooting and addressing what is experienced by the user, particularly where a network operator would not readily identify any poor performance or a fault as being associated with the network. As described herein, the various analyses, systems, methods, and devices, including the example area wide network analyses described herein, address improvements in identifying and troubleshooting these experiences.

In some embodiments described herein additional improvements in performance including limiting data transmitted across the network through classifying, filtering, and/or classifying and filtering data so that the collection and transmission of data may be performed efficiently and minimize user and/or network resources. In some embodiments described herein, user device performance is improved due to storing and collecting data at each call and/or change in call states with the transmission of user device data at terminal call states or determinations of degraded performance or faults. Transmission of data at such times may reduce amounts of data stored and/or amounts of data transmitted on a network being analyzed. Additionally details of improvements are discussed herein.

It should be readily appreciated that the embodiments of the systems, apparatus, and methods described herein may be configured in various additional and alternative manners in addition to those described herein.

### Definitions

As used herein, the terms “data,” “content,” “information,” and similar terms may be used interchangeably to refer to data capable of being transmitted, received, displayed, and/or stored in accordance with embodiments of the present disclosure. Thus, use of any such terms should not be taken to limit the spirit and scope of embodiments of the present disclosure. Further, where a system or user device is described herein to receive data from another system or user device, it will be appreciated that the data may be received directly from another user device or may be received indirectly via one or more intermediary user devices, such as, for example, one or more systems, servers, relays, routers, network access points, base stations, hosts, and/or the like, sometimes referred to herein as a “network.” Similarly, where a system or a user device is described herein to send data to another user device or system, it will be appreciated that the data may be sent directly or may be sent indirectly via one or more intermediary systems or user devices, such as, for example, one or more systems, servers, relays, routers, network access points, base stations, hosts, and/or the like.

As used herein, the term “circuitry” refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of “circuitry” applies to all uses of this term herein, including in any claims. As a further example, as used herein, the term “circuitry” also includes an implementation comprising one or more processors and/or portion(s) thereof and accompanying software and/or firmware. As another example, the term “circuitry” as used herein also includes, for example, an integrated circuit or applications processor integrated circuit for a mobile phone or a similar integrated circuit in a server, a cellular network device, system, other network device, and/or other computing device.

As used herein, a “computer-readable storage medium,” which refers to a physical storage medium (e.g., volatile or non-volatile memory device), may be differentiated from a “computer-readable transmission medium,” which refers to an electromagnetic signal.

The term “user device” or “device” refers to computer hardware and/or software that is configured to access one or more services made available to a user utilizing a network. In various circumstances, a user device may be associated with one or more applications running on the user device. User devices may include, without limitation, smart phones, mobile computers, automotive computing devices, tablet computers, laptop computers, wearables, and the like. In some embodiments, user devices may include, without limitation, mobile electronic devices, handheld electronic devices, or stationary/large electronic devices.

As used herein, the term “user device data” may refer to any information or data associated with a user device. As an example, as used herein, “user device data” may include, but is not limited to, “user device system data,” “user device application data,” and “user device events data,” each of which may comprise one or more types of data. As a further example, “user device system data” may include system settings data, memory data, system storage data, battery info data, battery stats usage data, screen settings data, location settings data, mobile network settings data, network data, radio signal data, cell identity data, Wi-Fi settings data, neighboring cell info data, phone call data, and power profile data. As yet a further example, “user device application data” may include application storage data, application activity data, and application data. As yet a further example, “user device events data” may include package events data, boot/shutdown events data, and setting changed events data. Additional examples of “user device data” are described herein, which may include exemplary data field names associated with user device data. In various embodiments, the user device data may include one or more data fields, which may be grouped into one or more user device data types. The following data fields described herein are examples of data fields that may be available, which may depend on the make and model of user device.

As used herein, the term “network event” may refer to any occurrence on or in association with one or more networks. In some embodiments, the network event may comprise one or more transmissions over a network, either in one direction or two-way transmission communications. For example, a network event may include phone calls, data streams, emails, text messages, other electronic messages such as email, video calls, video messages, or any other electromagnetic signals capable of being transmitted over a network. In some embodiments, a network event may comprise “user communication content”, which may include the content of such transmissions intended to be communicated, received, and understood by a human being. For example, with regard to a phone call, user communication content may comprise voice signals representative of the speaker's voice. In another example, with regard to an electronic message, the user communication content may comprise the human-readable text of the message. In some instances, access to user communication content may be restricted such that third parties other than the intended recipient may not be permitted to access the user communication content. While some embodiments herein refer to “calls” and data associated therewith, it would be understood by a person skilled in the art in light of the present disclosure that such “calls” are example embodiments of a network event analysis.

As used herein, the term “state data” may refer to any information associated with the state or condition of a user device. As an example of a user device of a smartphone, as used herein, “state data” may include, but is not limited to, states associated with a phone call, such as available, ringing, call active, call ended, and the like. Other examples of state data include information such as plugged in, airplane mode, and the like. In various embodiments, the state data may include and/or be directly or indirectly determined from one or more data fields described herein. Moreover, in various embodiments, certain user device data may characterize or be associated with one or more states, such as, but not limited to, signal strength at a start of call active state, signal strength at a call ended state, call termination reason (e.g., disconnect, hang up, etc.), or the like. In various embodiments discussed herein, a software application may collect user device data in response to detecting one or more state changes (e.g., call active to call ended).

The following are non-limiting examples of user device data fields, such as might be used and collected for a mobile device. In some embodiments, one or more software applications, including an operating system and/or API associated therewith, may be configured to return one or more of the following device data fields:

In various embodiments, system settings data may include the following data fields:

| | |
|---|---|
| time_zone | Time zone of the device. |
| time_realtime | Time since boot, including deep sleep. |
| time_uptime | Time since boot, excluding deep sleep. |
| build_id | Label of the OS (e.g., Android) build. |
| build_release | Release of the OS. |
| build_sdk | Android API SDK version number. |
| build_bootloader | Version of the bootloader software. |
| build_fingerprint | A string that uniquely identifies this build. |
| build_security_patch | The user-visible security patch level. |
| build_model | Model of the device model. |
| hardware_model | Model number of the iOS. |
| radio_version | String that specifies the version of the radio |
| | firmware (baseband) on Android. |
| adb_enabled | Whether Android Debug Bridge is enabled. |
| device_admin | Whether the mobile client is a device |
| | administrator. |

In various embodiments, the memory data may include the following data fields:

| | |
|---|---|
| free_memory | The amount of free memory on the device. |
| low_memory_threshold | The threshold of available memory at which we |
| | consider memory to be low and start killing |
| | background services and other non-extraneous |
| | processes. |
| total_memory | The amount of total memory on the device |
| | available for application usage. |

In various embodiments, the system storage data may include the following data fields:

| | |
|---|---|
| total_external_storage | Total size of sdcard in bytes. |
| free_external_storage | Total free space on sdcard in bytes. |
| total_internal_storage | Total internal memory in bytes. |
| free_internal_storage | Total available internal memory in bytes. |
| audio_storage_used | Storage used by audio files. |
| document_storage_used | Storage used by documents in bytes. |
| other_storage_used | Storage used by all other file types in bytes. |
| picture_storage_used | Storage used by pictures in bytes. |
| video_storage_used | Storage used by video. |
| app_storage_used | Storage used by all apps in bytes. |

In various embodiments, the battery info data may include the following data fields:

| | |
|---|---|
| battery_charging_technology | The technology used in the battery (e.g., Li-Ion). |
| battery_charging_type | The source of charging as string (e.g., unplugged, ac, usb, |
| | wireless, unknown). |
| battery_health | Current battery health (e.g., dead, good, over voltage, |
| | overheat, unspecified, failure, unknown). |
| battery_invalid_charger | True if the battery software determines that it has an |
| | invalid charger. |
| battery_level | Battery level (e.g., value between 0 and 1). |
| battery_state | Current state of the battery (e.g., charging, discharging, |
| | full, not charging, and unknown). |
| battery_temperature | Current battery temperature. |
| battery_voltage | Current battery voltage in mV. |
| battery_capacity | Remaining battery capacity as an integer percentage of |
| | total capacity (e.g., value between 0 and 100). |
| battery_charge_counter | Battery capacity in microampere-hours. |
| battery_charging_technology | The technology used in the batter (e.g., Li-Ion). |

In various embodiments, the battery stats usage data may include the following data fields:

| | |
|---|---|
| previous_timestamp | The timestamp of the previous recording. |
| time_battery_up | How long the device has been on battery (excluding deep |
| | sleep) since previous time stamp. |
| time_data_connection | Total time the phone had a data connection since previous |
| | time stamp. |
| time_phone_on | How long was the phone was used for VOICE calls since |
| | previous time stamp. |
| time_screen_on | How long was the screen on since previous timestamp. |
| time_screen_on_bright | How long was the screen on bright since previous |
| | timestamp. |
| time_signal_none | Total time the phone had no signal since previous |
| | timestamp. |
| time_signal_poor | Total time the phone had poor signal since previous |
| | timestamp. |
| time_signal_moderate | Total time the phone had moderate signal since previous |
| | timestamp. |
| time_signal_good | Total time the phone had good signal since previous |
| | timestamp. |
| time_signal_great | Total time the phone had great signal since previous |
| | timestamp. |

In various embodiments, the screen settings data may include the following data fields:

| | |
|---|---|
| auto_brightness_on | Whether the device has the auto brightness turned on. |
| screen_brightness | Screen brightness. |
| screen_off_timeout | The timeout before the screen turns off. |
| stay_on_while_plugged_in | ″Whether we keep the device on while the device is |
| | plugged in. For example: |
| | - 0 - to never stay on while plugged in |
| | - 1 - to stay on for AC charger |
| | - 2 -to stay on for USB charger These values can be OR- |
| | ed together |

In various embodiments, the location settings data may include the following data fields:

| | |
|---|---|
| gps_loc_provider | Returns the current enabled/disabled status of the GPS |
| | location provider. If the user has enabled this provider in |
| | the Settings menu, true is returned otherwise false is |
| | returned. |
| wireless_loc_provider | Returns the current enabled/disabled status of the wireless |
| | location provider. If the user has enabled this provider in |
| | the Settings menu, true is returned otherwise false is |
| | returned. |

In various embodiments, the mobile network settings data may include the following data fields:

| | |
|---|---|
| airplane_mode | Whether airplane mode is on. |
| country_iso | The ISO country code for the user's cellular service |
| | provider. |
| data_roaming_enabled | Whether the data traffic is allowed while roaming. |
| mobile_country_code | The mobile country code (MCC) for the user's cellular |
| | service provider. |
| mobile_network_code | The mobile network code (MNC) for the user's cellular |
| | service provider. |
| mobile_network_enabled | Whether mobile connection is enabled. On Android is 1 if |
| | the mobile network is in connected or connecting state. |
| | On iOS is 1 if the mobile network connection is active. |
| mobile_network_type | The type of radio currently being used. |
| network_available | Indicates whether an internet connection is available. |
| operator_name | The name of the user's home cellular service provider. It |
| | always represents the provider with whom the user has an |
| | account. If you configure a device for a carrier and then |
| | remove the SIM card, this setting retains the name of the |
| | carrier. |
| sim_country_code | The mobile country code (MCC) for the sim service |
| | provider. |
| sim_country_iso | The ISO country code for SIM provider. |
| sim_network_code | The mobile network code (MNC) for the sim service |
| | provider. |
| sim_operator_name | The SIM service provider name. It is collected only if the |
| | SIM is in ready state. |
| voice_network_type | One of cdma, gsm, sip, none or unknown. |
| voip_allowed | Indicates if the carrier allows VOIP calling. |

In various embodiments, the network data may include the following data fields:

| | |
|---|---|
| previous_timestamp | The timestamp of the previous recording. It is |
| | milliseconds since the Jan. 1, 1970 (UNIX epoch) |
| total_inbound_data | Total data received by the device in bytes since previous |
| | timestamp |
| total_inbound_mobile_data | Total data received by the device through the mobile |
| | network since previous timestamp |
| total_outbound_data | Total data sent by the device in bytes since previous |
| | timestamp |
| total_outbound_mobile_data | Total data sent by the device through the mobile network |
| | since previous timestamp |
| active_network_type | The type of the current active network connection (e.g., |
| | mobile, wifi, mobile_mms, mobile_supl, mobile_dun, |
| | mobile_hipri, wimax, Bluetooth, dummy, ethernet, |
| | mobile_fota, mobile_ims, mobile_cbs, wifi_p2p, |
| | unknown) |

In various embodiments, the radio signal data may include the following data fields:

| | |
|---|---|
| mobile_signal_strength | Signal level in 0 to 4 range |
| rs_gsm_asu_level | GSM RSSI in ASU. |
| rs_gsm_dbm | GSM signal strength as dBm. |
| rs_gsm_level | GSM abstract level value for the overall signal quality. |
| rs_gsm_ber | GSM Bit Error Rate. |
| rs_gsm_csq | A signal-to-noise ratio measurement that is used to |
| | ascertain the relative quality of the received cellular |
| | signal. |
| rs_gsm_rssi | GSM Received Signal Strength Indicator. |
| rs_gsm_timing_advance | GSM timing advance between 0 . . . 219 symbols (normally |
| | 0 . . . 63). |
| rs_lte_asu_level | LTE RSRP in ASU. |
| rs_lte_dbm | LTE signal strength in dBm. |
| rs_lte_level | LTE abstract level value for the overall signal quality. |
| rs_lte_cqi | LTE channel quality indicator. |
| rs_lte_rsrp | LTE reference signal received power in dBm. |
| rs_lte_rsrq | LTE reference signal received quality. |
| rs_lte_rssi | LTE Received Signal Strength Indication (RSSI) in dBm |
| | The value range is [−113, −51] inclusively. |
| rs_lte_rssnr | LTE reference signal signal-to-noise ratio. |
| rs_lte_timing_advance | LTE timing advance value for LTE, as a value in range of |
| | 0 . . . 1282 |
| rs_nr_asu_level | 5G NR RSRP in ASU. Asu is calculated based on 3GPP |
| | RSRP |
| rs_nr_dbm | 5G NR SS-RSRP as dBm value −140 . . . −44 dBm. |
| rs_nr_level | 5G NR signal level. |
| rs_nr_ss_rsrp | 5G NR 3GPP TS 38.215. |
| rs_nr_ss_rsrq | 5G NR 3GPP TS 38.215; 3GPP TS 38.133 section 10 |
| | Range: −43 dB to 20 dB. |
| rs_nr_ss_sinr | 5G NR 3GPP TS 38.215 Sec 5.1.*, 3GPP TS 38.133 |
| | 10.1.16.1 Range: −23 dB to 40 dB. |

In various embodiments, the cell identity data may include the following data fields:

| | |
|---|---|
| gsm_lac | 16-bit Location Area Code, 0 . . . 65535. |
| gsm_cid | 16-bit GSM Cell Identity, 0 . . . 65535. |
| gsm_arfcn | 16-bit GSM Absolute RF Channel Number. |
| gsm_bsic | 6-bit Base Station Identity Code. |
| lte_ci | 28-bit Cell Identity. |
| lte_pci | Physical Cell Id 0 . . . 503 |
| lte_tac | 16-bit Tracking Area Code |
| lte_earfcn | 18-bit Absolute RF Channel Number |
| lte_bandwidth | Cell bandwidth in kHz. |
| lte_bands | Get bands of the cell. |
| lte_additional_plmns | A list of additional PLMN IDs supported by this cell. |
| nr_nci | The 36-bit NR Cell Identity in range [0, 68719476735] |
| nr_pci | Physical Cell Id. |
| nr_tac | 24-bit Tracking Area Code. |
| nr_arfcn | Get the New Radio Absolute Radio Frequency Channel |
| | Number. |
| nr_bands | List of bands of the cell. |
| nr_additional_plmns | List of additional PLMN IDs supported by this cell. |
| cdma_basestation_id | cdma base station identification number, not collected if |
| | unknown. |
| cdma_basestation_latitude | cdma base station latitude in units of 0.25 seconds, not |
| | collected if unknown. |
| cdma_basestation_longitude | cdma base station longitude in units of 0.25 seconds, not |
| | collected if unknown. |
| cdma_basestation_nid | Cdma network identification number. |
| cdma_basestation_sid | Cdma system identification number (SID). |

In various embodiments, the Wi-Fi settings data may include the following data fields:

| | |
|---|---|
| wifi_enabled | Whether a Wi-Fi connection is active. |
| wifi_signal_strength | One of excellent, good, fair, very weak, or no signal. |
| wifi_signal_level | Level between 0 and wifi_signal_max_level |
| wifi_signal_max_level | Maximum signal level. |
| wifi_signal_rssi | Received signal strength indication |
| wifi_use_static_ip | Whether the Wi-Fi connection uses a static IP. |
| wifi_frequency | Wi-Fi connection frequency in wifi_frequency_units |
| wifi_frequency_units | Units for the frequency. (Ex MHz, GHz) |
| wifi_link_speed | Maximum speed of the link in wifi_link_speed_units |
| wifi_link_speed_units | Units of the wifi speed. (Ex. Mbps) |
| wifi_link_speed_rx | The current receive link speed in Mbps |
| wifi_link_speed_tx | The current transmit link speed in Mbps |
| wifi_max_link_speed_rx | The maximum supported receive link speed in Mbps |
| wifi_max_link_speed_tx | The maximum supported transmit link speed in Mbps |
| wifi_standard | Name of the Wi-Fi standard (e.g., Legacy, 11N, 11AC, |
| | 11AX or Unknown). |
| wifi_standard_id | Id of the standard. |

In various embodiments, the neighboring cell info data may include the following data fields:

| | |
|---|---|
| gsm_lac | 16-bit Location Area Code. |
| gsm_cid | 16-bit GSM Cell Identity. |
| gsm_arfcn | 16-bit GSM Absolute RF Channel Number. |
| gsm_bsic | 6-bit Base Station Identity Code. |
| lte_ci | 28-bit Cell Identity. |
| lte_pci | Physical Cell Id. |
| lte_tac | 16-bit Tracking Area Code. |
| lte_earfcn | 18-bit Absolute RF Channel Number. |
| lte_bandwidth | Cell bandwidth in kHz. |
| lte_bands | Get bands of the cell. |
| lte_additional_plmns | A list of additional PLMN IDs supported by this cell. |
| nr_nci | The 36-bit NR Cell Identity in range. |
| nr_pci | Physical Cell Id. |
| nr_tac | 24-bit Tracking Area Code. |
| nr_arfcn | Get the New Radio Absolute Radio Frequency Channel |
| | Number. |
| nr_bands | List of bands of the cell. |
| nr_additional_plmns | List of additional PLMN IDs supported by this cell. |
| cdma_basestation_id | cdma base station identification number, not collected if |
| | unknown. |
| cdma_basestation_latitude | cdma base station latitude in units of 0.25 seconds, not |
| | collected if unknown |
| cdma_basestation_longitude | cdma base station longitude in units of 0.25 seconds, not |
| | collected if unknown |
| cdma_basestation_nid | Cdma network identification number. |
| cdma_basestation_sid | Cdma system identification number (SID). |

In various embodiments, the phone call data may include the following data fields:

| | |
|---|---|
| phone_call_time | Timestamp of the call start time. |
| phone_call_direction | Direction of the call: INCOMING or OUTGOING. |
| phone_call_type | Network connection for the voice call (e.g., NR_5G, LTE, |
| | etc.). |
| phone_call_status | Status of the call when it ended (e.g., SUCCESS, |
| | MISSED). |
| phone_call_reason | Additional information when the status is different than |
| | SUCCESS. |
| phone_call_latitude | Latitude at the end of the call. |
| phone_call_longitude | Longitude at the end of the call. |

In various embodiments, the power profile data may include the following data fields:

| | |
|---|---|
| power_audio | Additional power used when audio decoding/encoding |
| | via DSP. |
| power_battery_capacity | Total battery capacity in mAh. |
| power_bluetooth_active | Additional power used when playing audio through |
| | Bluetooth A2DP. |
| power_bluetooth_on | Additional power used when Bluetooth is turned on but |
| | idle. |
| power_gps_on | Additional power used when GPS is acquiring a signal. |
| power_radio_active | Additional power used when cellular radio is |
| | transmitting/receiving. |
| power_radio_on | Additional power used when the cellular radio is on. |
| | Multi-value entry, one per signal strength (e.g., no |
| | signal, weak, moderate, strong, etc.). |
| power_radio_scanning | Additional power used when cellular radio is paging the |
| | tower. |
| power_screen_full | Additional power used when screen is at maximum |
| | brightness, compared to screen at minimum brightness |
| power_screen on | Additional power used when screen is turned on at |
| | minimum brightness. |
| power_sensor_accelerometer | Additional power used by the accelerometer. |
| power_sensor_ambient_temperature | Additional power used by the ambient temperature |
| | sensor. |
| power_sensor_gravity | Additional power used by the gravity sensor. |
| power_sensor_gyroscope | Additional power used by the gyroscope. |
| power_sensor_light | Additional power used by the light sensor. |
| power_sensor linear_acceleration | Additional power used by the linear acceleration sensor. |
| power_sensor_magnetic_field | Additional power used by the magnetic field sensor. |
| power_sensor_pressure | Additional power used by the pressure sensor. |
| power_sensor_proximity | Additional power used by the proximity sensor. |
| power_sensor_relative humidity | Additional power used by the humidity sensor. |
| power_sensor_rotation vector | Additional power used by the rotation sensor. |
| power_video | Additional power used when video decoding via DSP. |
| power_wifi_active | Additional power used when transmitting or receiving |
| | over Wi-Fi. |
| power_wifi_on | Additional power used when Wi-Fi is turned on but not |
| | receiving, transmitting, or scanning. |
| power_wifi_scan | Additional power used when Wi-Fi is scanning for |
| | access points. |

In various embodiments, the application storage data may include the following data fields:

| | |
|---|---|
| package_name | Application package name. |
| package_version_code | Application version code. |
| package_cache_size | Main storage used by |
| | application cache in bytes. |
| package_code_size | Main storage used by |
| | application code in bytes. |
| package_data_size | Main storage used by |
| | application data in bytes. |

In various embodiments, the application activity data may include the following data fields:

| | |
|---|---|
| previous_timestamp | The timestamp of the previous recording. (e.g., |
| | milliseconds since Jan. 1, 1970 (UNIX epoch)). |
| package_name | Application package name or the name of the system |
| | component: |
| | WIFI - power used by WiFi radio excluding the power |
| | used by apps; |
| | BLUETOOTH - Bluetooth component; |
| | IDLE - power used by cpu while the phone had the screen |
| | off; |
| | CELL - power used by the phone's radio, accounting for |
| | different signal strengths and searching for signal; |
| | PHONE- power used during voice calls; |
| | SCREEN - power used by the screen accounting for |
| | different levels of brightness. |
| package_version_code | Application version code or Null if a system component. |
| power | Absolute power in mA has been used by this app since |
| | previous timestamp. |
| power_percentage | Percentage of power used by this app since previous |
| | timestamp. The total power accounts for all apps and |
| | system components (e.g., screen, GPS, WiFi, bluetooth, |
| | phone idle, phone in use, etc.). |
| cpu_foreground_time | Total cpu time used by this app in foreground since |
| | previous timestamp. |
| service_crash_count | Number of times a service associated with the app |
| | crashed. |
| time_audio_on | Audio on time since previous timestamp. |
| time_video_on | Video on time since previous timestamp. |

In various embodiments, the application data may include the following data fields:

| | |
|---|---|
| previous_timestamp | The timestamp of the previous recording. It is |
| | milliseconds since the Jan. 1, 1970 (UNIX epoch). |
| package_name | Application package name. |
| package_version_code | Application version code. |
| total_inbound_data | Total data received by this app in bytes since previous |
| | timestamp. |
| total_outbound_data | Total data sent by this app in bytes since previous |
| | timestamp. |
| total_inbound_mobile_data | Total data received by the device through the mobile |
| total_outbound_mobile_data | network since previous timestamp. |
| | Total data sent by the device through the mobile network |
| | since previous timestamp. |

In various embodiments, the package events data may include the following data fields:

| | |
|---|---|
| Name | Name of event. |
| Extras | Additional properties in Json format. |
| app_package | Application package name. |
| app_name | Application name. |
| app_version_name | Application version. |
| app_version_code | Application version code. |

In various embodiments, the boot/shutdown events data may include the following data fields:

| | |
|---|---|
| name | Name of event (e.g., BootEvent, ShutdownEvent, etc.) |
| extras | Additional properties in Json format. |
| battery_charging_technology | The technology used in the batter (e.g., Li-Ion). |
| battery_charging_type | The source of charging as string (e.g., unplugged, ac, usb, |
| | wireless, unknown, etc.). |
| battery_health | Current battery health (e.g., dead, good, over voltage, |
| | overheat, unspecified failure, unknown, etc.) |
| battery_level | Battery level (e.g., 0 and 1). |
| battery_state | Current state of the battery (e.g., charging, discharging, |
| | full, not charging, unknown, etc.) |
| battery_temperature | Current battery temperature. |
| battery_voltage | Current battery voltage in mV. |

In various embodiments, the setting changed events data may include the following data fields:

| | |
|---|---|
| Name | SettingChangeEvent. |
| Extras | Additional properties in Json format. |
| Key | Name of the setting. |
| Old | Previous value. |
| New | Current value. |

In various embodiments, some or all of the data types may also be accompanied by common data, which may include the following data fields:

| | |
|---|---|
| client_id | Client identifier |
| Timestamp | UTC UNIX time when the metrics were collected on client. |
| upload_timestamp | UTC UNIX time when the metrics were uploaded. |
| client_platform | Platform of the client (e.g., Android or iOS) |
| client_package | Package name of the host client app. |
| client_version_code | Version code of the host client app. |
| library_version_code | Version code of library |
| build_model | Device build model name. |
| client_version_name | Version name of the host client app. |
| library_version_name | Version name of library. |
| user_properties | Properties set by the client. |

As used herein, the term “user device-specific fault” may refer to a fault associated with a user device. As an example, a user device-specific fault may include fault with the hardware of the user device, such as a processor fault, a memory fault, a sensor fault, a communications circuitry fault, a display fault, and/or the like. As further example, a user device-specific fault may include a fault with the software of the computing device, such as application fault, operating system fault, and/or the like. In some embodiments a user device-specific fault may be resolvable via software or hardware repair, update, or modification to the user device(s).

As used herein, the term “network-specific fault” may include, but is not limited to, a fault associated with a network or a portion of a network, such as network tower. In some embodiments a network-specific fault may be resolvable via software or hardware repair, update, or modification to the network or portion of the network.

As used herein, the term “data object” refers to electronically managed data capable of being collectively transmitted, received, and/or stored. A data object may be defined by one or more associated data structures, which may include at least a data structure identifier that uniquely identifies a data structure represented by the data object and/or the data object itself. For example, a data object may refer to a collection of data and instructions that represent data of a user device and/or data of a plurality of user devices. For example, a data object may comprise one or more data structures defined by data properties. In some embodiments, a data object may be associated with any of a number of related data objects, such as a user device data object. For example, a data object utilized by a user device or a device information system may comprise a data object identifier, a data structure identifier, a file(s) created and stored within the device information system, metadata associated with one or more data elements, structures, objects, and/or packets, and the like, or any combination thereof.

### Network Environment Overview

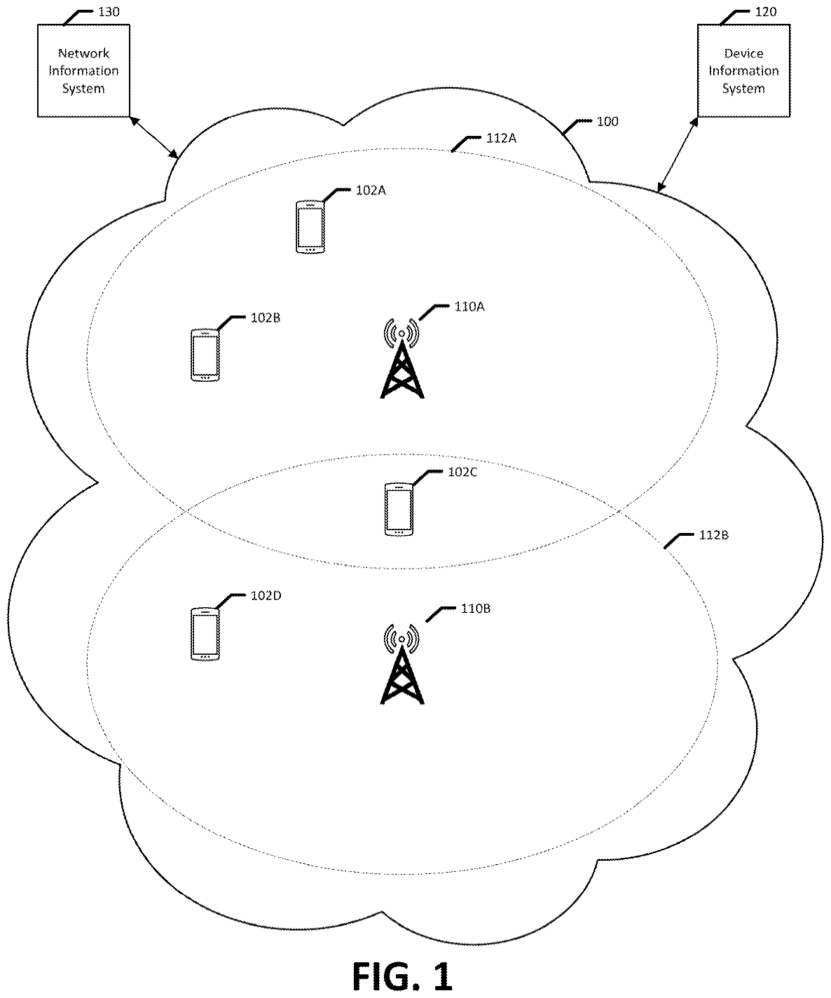

FIG. 1 illustrates a network environment within which embodiments of the present disclosure may operate. It will be appreciated that the network environment as well as the illustrations in other figures are each provided as an example of an embodiment(s) and should not be construed to narrow the scope or spirit of the disclosure in any way. In this regard, the scope of the disclosure encompasses many potential embodiments in addition to those illustrated and described herein. As such, while FIG. 1 illustrates one example of a network environment for network analysis, numerous other configurations may also be used to implement embodiments of the present disclosure.

The network environment of FIG. 1 includes at least one network 100. One or more user devices 102 (e.g., 102A, 102B, 102C, and 102D) may be wirelessly connected to network 100 via one or more network towers 110 (e.g., 110A, 110B). In some embodiments, the network 100 may comprise a wide area network operated by one or more carriers. In some embodiments, the network may comprise a local or ad hoc network.

While one network 100 is illustrated in FIG. 1, it will be appreciated that multiple networks may be present in the same area. In an exemplary embodiment there may be a 5G network or an LTE network and a user device 102 may choose between the available networks, such as with a setting set by a user or set automatically by an application. It will be appreciated that when a network 100 is referred to herein, the reference may refer to any type of network. It will also be appreciated that while the network environment 100 illustrated FIG. 1 depicts network towers 110, a network 100 may be connected via wired connections between towers and other network equipment to allow for wireless communication for one or more user devices 102. As used herein the term “tower” is inclusive of cellular towers as part of a cellular network and also includes any other access point by which a device gains access to a network, including routers, modems, or the like. In some embodiments, the towers may comprise wireless access points to the network.

While FIG. 1 illustrates two network towers 110A, 110B, a network 100 may include a large number of network towers 110 in order to cover a large geographic area. In some embodiments, the network may include any combination of wired and wireless communication infrastructure capable of communicating among devices in the same or different geographic locations. FIG. 1 depicts an embodiment where coverage of the network 100 with network towers 110 includes overlapping coverage by the two network towers 110A, 110B for user device 102C. In various embodiments with overlapping coverage, user device 102C may communicate with and/or receive and transmit data to network towers 110A and 110B or may select one of the available towers.

User devices 102 may be traveling, and in an embodiment where user device 102C may be traveling from the coverage area of network tower 110A into the coverage area of network tower 110B, the network towers 110 may be configured to hand off the user device 102C as it passes through the coverage area of the network towers 110 that make up a portion of network 100 that user device 102C utilizes while traveling. In various embodiments, such travel of a user device 102C may have the user device 102C utilize multiple towers to communicate with other user devices 102 during the travel. Multiple network towers 110 and/or equipment associated with the network towers 110 may collectively be referred to as a portion of a network 100.

The network environment of FIG. 1 may also include a device information system 120 and a network information system 130. In various embodiments, the device information system 120 may communicate with one or more user devices 102 via the network 100. The communication between a user device 102 and a device information system 120 may occur via electronic communications, which may be part of an application running on the user device 100. The user device 100 may, such as with the application, provide various data to the device information system 120 as described herein. In some embodiments, the network information system 130 may be associated with the network and may communicate directly with the tower(s) 110A, 110B and/or the device information system 120 for facilitating operation and maintenance of the network. In an example embodiment, the network information system 130 may be remote from the device information system 120. The device information system 120 and the network information system 130 may be located within the network 100 or may be located remotely away from network 100. In some embodiments, the functionality associated with the device information system and the network information system may be performed by a single system and may be referred to as a respective device information system or the network information system depending upon the functionality being called upon.

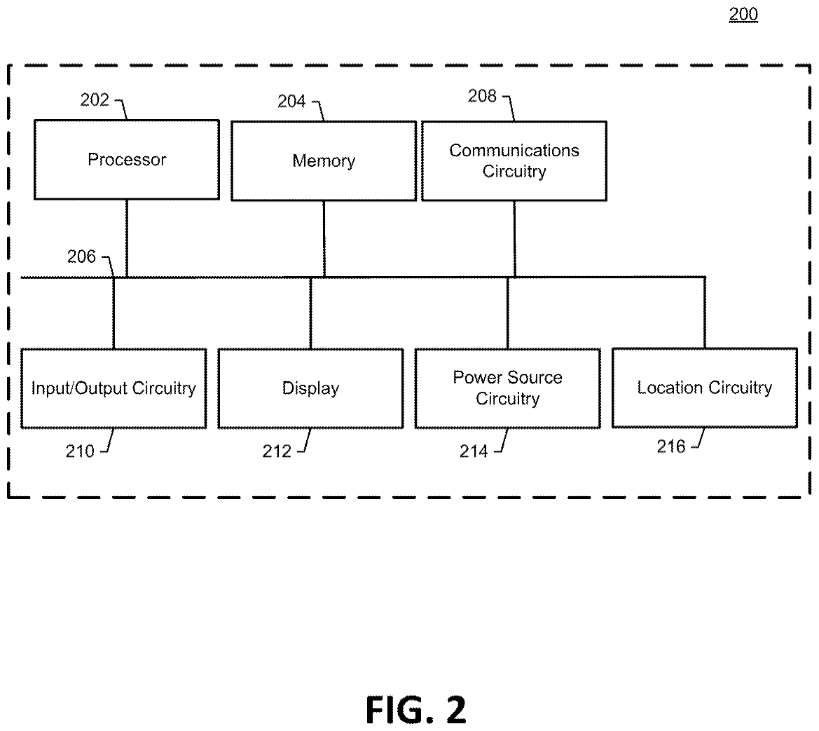

FIG. 2 illustrates an example block diagram of an example user device 102 in accordance with example embodiments described herein. For example, the user device 102 may comprise apparatus 200 and may include one or more components, modules, or circuitries that are in electronic commutations with one another. For example, in some embodiments, the example user device 102 may include a cellular phone or other mobile or stationary electronic device associated with a user. The apparatus 200 may include a processor 202, memory 204, communications circuitry 208, input/output circuitry 210, display 212, power source circuitry 214, and location circuitry 216 that are in electronic communication with one another via a system bus 206. In some embodiments, system bus 206 refers to a computer bus that connects these components so as to enable data transfer and communications between these components. Additionally, or alternatively, the apparatus 200 may be in other form(s) and/or may comprise other component(s).

The processor 202 may be embodied in a number of different ways and may, for example, include one or more processing devices configured to perform independently. Additionally, or alternatively, the processor 202 may include one or more processors configured in tandem via a bus to enable independent execution of instructions, pipelining, and/or multithreading. Additionally, in some embodiments, the processor 202 may include one or processors, some which may be referred to as sub-processors, to control one or more components, modules, or circuitry of apparatus 200.

The processor 202 may be embodied as one or more complex programmable logic devices (CPLDs), microprocessors, multi-core processors, co-processing entities, application-specific instruction-set processors (ASIPs), and/or controllers. Further, the processor 202 may be embodied as one or more other processing devices or circuitry. The term circuitry may refer to a hardware embodiment or a combination of hardware and computer program products. Thus, the processor 202 may be embodied as integrated circuits, application specific integrated circuits (ASICs), field programmable gate arrays (FPGAs), programmable logic arrays (PLAs), hardware accelerators, another circuitry, and/or the like. As will therefore be understood, the processor 202 may be configured for a particular use or configured to execute instructions stored in volatile or non-volatile media or otherwise accessible to the processor 202. As such, whether configured by hardware or computer program products, or by a combination thereof, the processor 202 may be capable of performing steps or operations according to embodiments of the present disclosure when configured accordingly.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, the processor may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor to perform the algorithms and/or operations described herein when the instructions are executed.

In some embodiments, the memory 204 may be non-transitory and may include, for example, one or more volatile and/or non-volatile memories. In other words, for example, the memory 204 may be an electronic storage device (e.g., a computer readable storage medium). The memory 204 may be configured to store information, data, content, applications, instructions, or the like, for enabling the apparatus 200 to carry out various functions in accordance with example embodiments of the present disclosure. In this regard, the memory 204 may be preconfigured to include computer-coded instructions (e.g., computer program code), and/or dynamically be configured to store such computer-coded instructions for execution by the processor 202.

In an example embodiment, the apparatus 200 further includes a communications circuitry 208 that may enable the apparatus 200 to transmit data and/or information to other devices or systems through a network (such as, but not limited to, the user devices 102, device information system 120, and/or network information system 130 as shown in FIG. 1). The communications circuitry 208 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 208 may include, for example, a network interface for enabling communications with a wired or wireless communication network. For example, the communications circuitry 208 may include one or more circuitries, network interface cards, antennae, buses, switches, routers, modems, and supporting hardware and/or software, or any other device suitable for enabling communications via a network. Additionally, or alternatively, the communication interface may include the circuitry for interacting with the antenna(s) to cause transmission of signals via the antenna(s) or to handle receipt of signals received via the antenna(s).

In some embodiments, the apparatus 200 may include input/output circuitry 210 that may, in turn, be in communication with the processor 202 to provide output to the user and, in some embodiments, to receive an indication of a user input. The input/output circuitry 210 may comprise an interface or the like. In some embodiments, the input/output circuitry 210 may include a keyboard, a mouse, a joystick, a touch screen, touch areas, soft keys, a microphone, a speaker, or other input/output mechanisms. The processor 202 and/or input/output circuitry 210 may be configured to control one or more functions of one or more user interface elements through computer program instructions (e.g., software and/or firmware) stored on a memory accessible to the processor (e.g., memory 204).

In some embodiments, the apparatus 200 may include the display 212 that may, in turn, be in communication with the processor 202 to display user interfaces (such as, but not limited to, display of a call and/or an application). In some embodiments of the present disclosure, the display 212 may include a liquid crystal display (LCD), a light-emitting diode (LED) display, a plasma (PDP) display, a quantum dot (QLED) display, and/or the like.

In some embodiments, the apparatus 200 may include power source circuitry 214. In some embodiments, the power source circuitry 214 may include one or more inter power sources (e.g., batteries) and/or connections to one or more external power sources. The power source circuitry 214 may further include circuitry that connects and controls the distribution of power from these internal and/or external power sources to one or more other components, modules, and/or circuitries of apparatus 200 described herein.

In some embodiments, the apparatus 200 may include location circuitry 216. The location circuitry 216 may be any means such as a device or circuitry embodied in either hardware or a combination of hardware and software that is configured to receive and/or transmit data for determining a location of apparatus 200, such as, but not limited to, GPS circuitry. In some embodiments, the location circuitry 216 may include, for example, an interface for enabling communications with global position system, such as with one or more GPS satellites. In some embodiments, the location circuitry 216 may share one or more circuitries with communications circuitry 208, such as when location data may be provided or associated with one or more portions of the network 100.

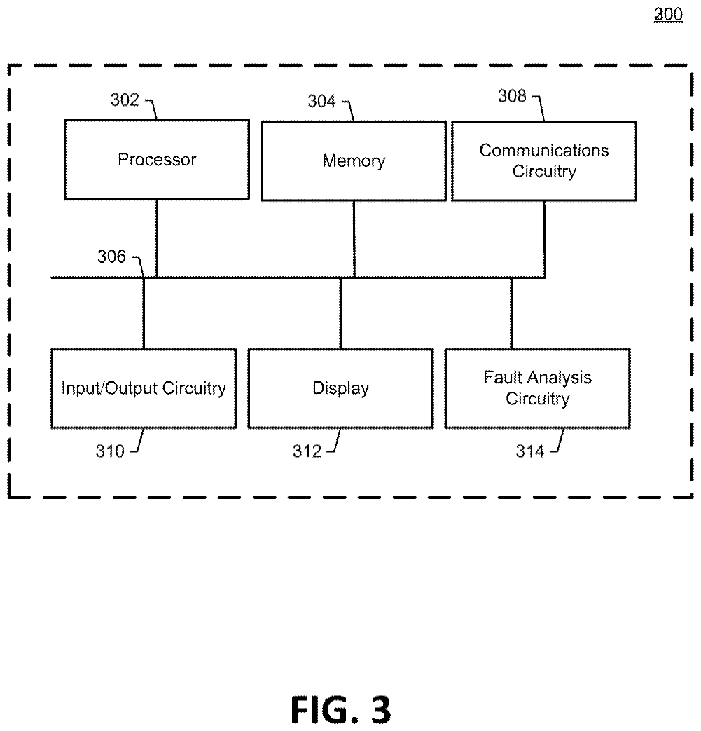

FIG. 3 illustrates an example block diagram of an apparatus 300 of a system, such as device information system 120 or network information system 130, in accordance with example embodiments described herein. In various embodiments, a system may include one or more apparatus 300, which may be utilized in conjunction with each other and/or one or more servers or databases. For example, an apparatus 300 may include one or more components, modules, or circuitries that are in electronic commutations with one another. The apparatus 300 may include a processor 302, memory 304, communications circuitry 308, input/output circuitry 310, display 312 that are in electronic communication with one another via a system bus 306. In some embodiments, the system bus 306 refers to a computer bus that connects these components so as to enable data transfer and communications between these components. Additionally, or alternatively, the apparatus 300 may be in other form(s) and/or may comprise other component(s).

The processor 302 may be embodied in a number of different ways and may, for example, include one or more processing devices configured to perform independently. Additionally, or alternatively, the processor 302 may include one or more processors configured in tandem via a bus to enable independent execution of instructions, pipelining, and/or multithreading. Additionally, in some embodiments, the processor 302 may include one or processors, some which may be referred to as sub-processors, to control one or more components, modules, or circuitry of apparatus 300.

The processor 302 may be embodied as one or more complex programmable logic devices (CPLDs), microprocessors, multi-core processors, co-processing entities, application-specific instruction-set processors (ASIPs), and/or controllers. Further, the processor 302 may be embodied as one or more other processing devices or circuitry. The term circuitry may refer to a hardware embodiment or a combination of hardware and computer program products. Thus, the processor 302 may be embodied as integrated circuits, application specific integrated circuits (ASICs), field programmable gate arrays (FPGAs), programmable logic arrays (PLAs), hardware accelerators, another circuitry, and/or the like. As will therefore be understood, the processor 302 may be configured for a particular use or configured to execute instructions stored in volatile or non-volatile media or otherwise accessible to the processor 302. As such, whether configured by hardware or computer program products, or by a combination thereof, the processor 302 may be capable of performing steps or operations according to embodiments of the present disclosure when configured accordingly.

In an example embodiment, the processor 302 may be configured to execute instructions stored in the memory 304 or otherwise accessible to the processor. Alternatively, or additionally, the processor 302 may be configured to execute hard-coded functionality. As such, whether configured by hardware or software methods, or by a combination thereof, the processor may represent an entity (e.g., physically embodied in circuitry) capable of performing operations according to an embodiment of the present disclosure while configured accordingly. Alternatively, as another example, when the processor 302 is embodied as an executor of software instructions, the instructions may specifically configure the processor to perform the algorithms and/or operations described herein when the instructions are executed.

In some embodiments, the memory 304 may be non-transitory and may include, for example, one or more volatile and/or non-volatile memories. In other words, for example, the memory 304 may be an electronic storage device (e.g., a computer readable storage medium). The memory 304 may be configured to store information, data, content, applications, instructions, or the like, for enabling the apparatus 300 to carry out various functions in accordance with example embodiments of the present disclosure. In this regard, the memory 304 may be preconfigured to include computer-coded instructions (e.g., computer program code), and/or dynamically be configured to store such computer-coded instructions for execution by the processor 302.

In an example embodiment, the apparatus 300 further includes a communications circuitry 308 that may enable the apparatus 300 to transmit data and/or information to other devices or systems through a network (such as, but not limited to, the user devices 102, device information system 120, and/or network information system 130 as shown in FIG. 1). The communications circuitry 308 may be any means such as a device or circuitry embodied in either hardware or a combination of hardware and software that is configured to receive and/or transmit data from/to a network and/or any other device, circuitry, or module in communication with the apparatus 300. In this regard, the communications circuitry 308 may include, for example, a network interface for enabling communications with a wired or wireless communication network. For example, the communications circuitry 308 may include one or more circuitries, network interface cards, antennae, buses, switches, routers, modems, and supporting hardware and/or software, or any other device suitable for enabling communications via a network. Additionally, or alternatively, the communication interface may include the circuitry for interacting with the antenna(s) to cause transmission of signals via the antenna(s) or to handle receipt of signals received via the antenna(s).

In some embodiments, the apparatus 300 may include input/output circuitry 310 that may, in turn, be in communication with the processor 302 to provide output to the user and, in some embodiments, to receive an indication of a user input. The input/output circuitry 310 may comprise an interface or the like. In some embodiments, the input/output circuitry 310 may also include a keyboard, a mouse, a joystick, a touch screen, touch areas, soft keys, a microphone, a speaker, or other input/output mechanisms. The processor 302 and/or input/output circuitry 310 may be configured to control one or more functions of one or more user interface elements through computer program instructions (e.g., software and/or firmware) stored on a memory accessible to the processor (e.g., memory 304).

In some embodiments, the apparatus 300 may include fault analysis circuitry 314 which may be configured to perform various user device data, user-device-specific fault, network-specific fault, modeling, machine learning, and other data processing and analysis processes discussed herein. The fault analysis circuitry 314 may be any means such as a device or circuitry embodied in either hardware, software, or a combination of hardware and software that is configured to perform the analysis described herein. In some embodiments the fault analysis circuitry 314 may be separate circuitry within the apparatus 300, and in some embodiments, the fault analysis circuitry 314 may be hardware, software, or a combination of hardware and software executing in conjunction with one or more other components of the apparatus, such as software executed via the processor 302 and stored on the memory 304.

In some embodiments, the apparatus 300 may include the display 312 that may, in turn, be in communication with the processor 302 to display user interfaces (such as, but not limited to, display of a call and/or an application). In some embodiments of the present disclosure, the display 312 may include a liquid crystal display (LCD), a light-emitting diode (LED) display, a plasma (PDP) display, a quantum dot (QLED) display, and/or the like.

Having now generally described several embodiments of a network environment, network analysis associated with such embodiments will now be described in accordance with several example embodiments.

### Example Operations

In some example embodiments, in order to facilitate area wide network analysis, including for determining network performance and health and also identifying network-specific faults and user-device specific faults, a user device 102 may be configured to monitor, collect, store, classify, filter, and transmit user device data, including by generating one or more user device data objects.

In some embodiments, a user device 102 may be configured by one or more applications installed on the user device 102. Such applications may be provided by the manufacturer of the user device 102 or may be downloaded and installed on the user device 102 by the user. In various embodiments, an application's access to the user device 102 may require express permission from the user for each action taken by the application. Alternatively, an application may only need receive permission from a user one time, such as during a user's initial interaction with the application. In another alternative, the application may be granted permission(s) for actions it takes automatically or may not need permissions. For example, various embodiments may allow for a user to opt-in or opt-out of providing various permissions.

In some embodiments, the user may be prompted via the user device to grant permissions for collection of the user device data. For example, in some embodiments, the user device data may be collected by a software application operating on the user device. In some embodiments, the software application may be a temporary piece of software (e.g., browser-based) operating while the user runs the application. In some embodiments, the software application may be installed on the user device. In some embodiments, the software application may comprise an APK installable in one or more devices and/or may be distributed as part of an SDK for use by one or more carriers or other third parties. In some embodiments, the software application may trigger rendering of one or more graphical user interface elements on a screen of the user device to enable one or more permissions. In some embodiments, the graphical user interface element may include a permission request and a selectable button or other user-operable element configured to receive user approval or disapproval of the permission request. The permission request may comprise a request for one or more enhanced permissions, such as permission to collect any of the data discussed herein, whether individually or collectively. In some embodiments, the user may grant permission for the software application to run in the background while the device is in standby or the software application is otherwise not active on the user's screen. In such embodiments, the software application may be authorized to listen to the user device states and collect the various data described herein either in the background or the foreground.

In some embodiments, user device data and user device data object contains time stamps with a date and time, such as in one or more data fields. In some embodiments, the device information system 120 and/or the network information system 130 may coordinate with one or more user devices 102 to set a date and time. In some embodiments, such coordination may be with one or more applications operating on the user device 102.

In various embodiments, an application may configure the user device 102 monitor, collect, store, classify, filter, and transmit user device data. Monitoring may include, but is not limited to, monitoring a user device 102 for changes in user device data, such as updates and/or changes to one or more data fields. An update or a change in a data field may be associated with an action taken by the user device 102, such as receiving a phone call, initiating a video chat, starting an application, ending an application, etc. A change in user device data may trigger the collection and storage of user device data. There may be a large amount of user device data that may be monitored, collected, and stored, but not all of this user device data may be relevant to network analysis and collection and storage of large amounts of data may lead to poor performance of user device 102. Moreover, the collection and transmission of large amounts of data may degrade not only the performance of the user device 102 but also the network 100. Additionally, transmission of larger amounts of data on the network may lead to poorer performance of a user device 102 on the network due to low bandwidth and/or low accessibility to other network resources, which may increase latency in interactions overs the network.

In some embodiments, one or more state changes may be detected by a software application running on the user device, such as by a software listener collecting state data. In response to detecting one or more predetermined state changes (e.g., phone ringing, call active, call dropped, blocked, etc.), the software application may collect, via the user device, user device data according to the various embodiments herein. In such embodiments, any detectable user device event (e.g., state changes) may serve as the trigger for data collection.

For example, collection and storage of large amounts of data increases processor and memory usage, which also drains battery life as a user 102 performs such actions. In a further example, the transmission of large amounts of data, particularly over the numerous user devices, increases the burden on the network 100 to transmit and receive user device data, which may lead to users on the user device experiencing a slowdown in performance, particularly if a user is using an older make and model of user device. Thus, in addition to having the data from user devices 102 to analyze a network from a user's perspective being an improvement, embodiments described herein may also improve performance with the amount of data collected and stored being classified and filtered as described herein. Additionally, in various embodiments, the collection and transmission may be timed with one or more triggers to improve when and how much data is collected or transmitted, which may improve network performance by lowering the network traffic burden on the network.

In some embodiments, the user device data collected by the user device may include, but not be limited to, state information, device hardware data (e.g., signal strength and latency, battery level, processor usage, memory available, etc.), device information (e.g., make, model, etc.), event data (e.g., changes in state, such as airplane mode on/off), historical data, location (e.g., GPS, cell tower calculated location, or other physical location data associated with the device), network ID information (e.g., tower ID, connection type (e.g., cellular, Wi-Fi, etc.)), network event termination reason (e.g., dropped, blocked, successful, unsuccessful, etc.). Data associated with the foregoing, such as duration and/or timestamps and other metadata may be collected for each as well.

In some embodiments, the user device (e.g., via a software application) may be configured to collect indirect data, which may comprise any user device data without user communication content. In some embodiments, the indirect data may be generated by collecting only some data generated by the user device, and in some embodiments, the indirect data may be generated by removing or obscuring user communication content in the user device data.

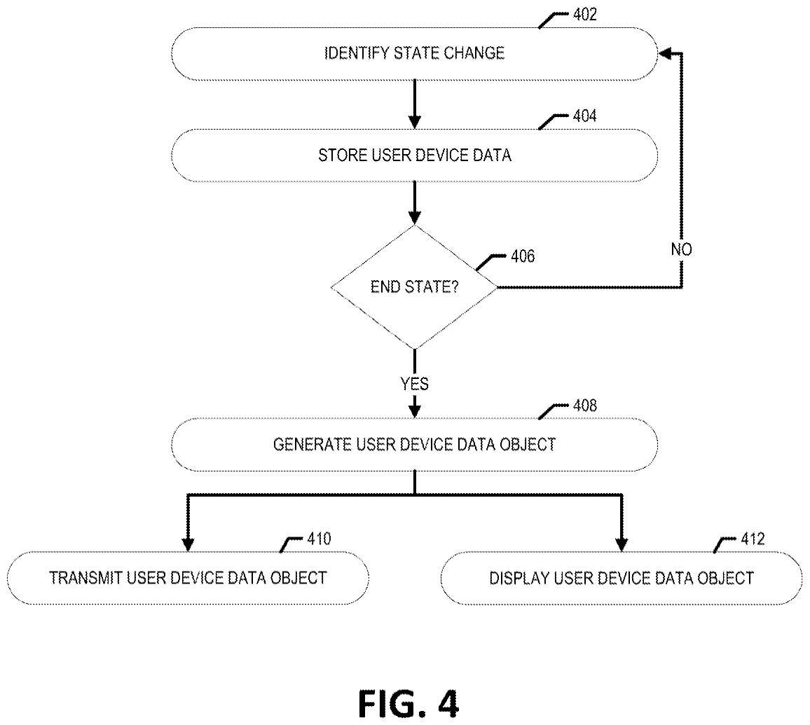

FIG. 4 illustrates a flowchart according to an example method performed by a user device 102 to generate and transmit user device data. In various embodiments, the user device data may be transmitted in a user device data object, which may be transmitted to a device information system 120 for use in analysis, including area wide network analysis.

At operation 402, the user device 102 identifies a state change. In various embodiments user device 102 monitors for a change in user device data, such as a state change associated with initiating or receiving a phone call. In an example embodiment, a user device 102A may be in an available mode where the user device 102A is available to receive a phone call from a second user device 102B and this state may be monitored for a change.

In the example of a call (e.g., voice call, video call, etc.), a user device 102 may go through multiple states and thus multiple state changes over the course of the call. Exemplary states include, but are not limited to, available, ringing, answered, connected, terminated, dropped, blocked, etc. Some of the user device states may proceed in a specific order, which may be indicative of a successful call or an unsuccessful call. For example, certain states and/or patterns of states may be associated with a successful call (e.g., available, ringing, answered, connected, terminated) and some may be associated with an unsuccessful call (e.g., available, ringing, dropped, blocked). The user device 102 monitoring for state changes may identify a state change, such as between a state of available and a state of ringing, and the change may be a trigger to collect user device data. A change in state from available to ringing may be due to a user initiating a call or a user receiving a call on the user device 102. In some embodiments, a network event may be defined by one or more network events (e.g., ringing, connected, terminated). In various embodiments, determining a pattern or sequence of monitored states may have been generated by a machine learning model as described herein.

At operation 404, the user device 102 stores user device data. The storage of user device data may be after collecting user device data triggered by a state change. The user device data may be stored in user device memory, which may be in a unique format. In various embodiments related to calls, the stored data may be in the form of a call log that includes call specific data. In alternative embodiments, the user device data may be stored in a data log. Such a collection and storage of data at state changes, among other things, reduces the amount of collection and storage of data compared to user devices 102 that may store data continuously. It is additionally an improvement over devices that may collect and store data periodically, which may fail to capture data at the time of the state change and, thus, may fail to capture an accurate record of a user experience at that time.

In an example where the state change from available to ringing is a trigger, the user device 102 may store data associated with the user initiating the call or with the call being initiated remotely. In this example, the data stored may include, but is not limited to, any one or more of the data types and data fields described herein, including, but not limited to, any of the user device data identified above.

At operation 406, the user device 102 monitors state changes to determine if an identified state change is a terminal state, such as a state associated with the end of a call. In some embodiments, a terminal state may be dependent on the type of action being taken by the user device 102 (e.g., end of a phone call, end of a video call, an application closing, entering airplane mode, exiting airplane mode, ending VPN session, etc.). If the identified state change is not a terminal state, user device 102 continues to monitor state changes at 402. If the identified state change is a terminal state, the user device 102 continues to operation 408.

At operation 408, the user device 102 generates a user device data object from the stored user device data. In various embodiments, the user device data object may include all of the user device data stored at each of the state changes associated with receiving or making a call.

In some embodiments, generation of a user device data object may only occur when a particular terminal state change or other trigger is identified. For example, a user device 102 may generate a user device data object when a terminal state change associated with a dropped call, blocked call, ended call, or other termination of a network event is identified. In some embodiments, the terminal state change may fall into a subset of “successful” network events (e.g., call successfully completed) and unsuccessful network events (e.g., call blocked, dropped, etc.). In some embodiments, a user device data object may be generated at each terminal state.

In some embodiments, generation of the device data object may also include classifying and/or filtering of the user device data, including removing redundant user device data. For example, in some embodiment monitoring for specific terminal states, such as dropped call, blocked call, ended call, or other termination of a network event, classifying and filtering of data may exclude data that is not associated with respective network event and/or the termination of the network event. In some embodiments, a terminal state is one which puts the user device into an “available” state (e.g., back to an idle or standby state). The state changes may be associated with one or more user device applications and, thus, the classifying and filtering of data may be associated with excluding user device data not associated with the application or a particular terminal state associated with the application or one or more actions taken by the application (e.g., ending a video call by a video chat application).

In various embodiments, the user device data object generated may include historical data. In some embodiments with dropped calls, historical data may include user device data associated with prior successful and/or prior dropped calls, which may be stored on the user device 102 or on a separate server and retrieved to perform the analyses discussed herein. The historical data may also include device state data for a period of time prior to the first state change associated with a call, including, but not limited to, time since the user device was turned on, rebooted, or placed into airplane or standby modes. Such time periods may be adjustable depending on the states being monitored for and/or the application monitoring the user device 102.

In some embodiments, the terminal state change may be identified as a terminal state change associated with a fault and, thus, the user device 102 may generate and include an indication of a fault. In some embodiments, discussed herein, an indication of a fault may be generated upon analysis of the user device data object by a secondary computing system, such as the device information system. What is determined as a fault and, thus, what terminal states are associated with a fault, may be associated with the operation being performed by the user device 102 (e.g., receiving a call, etc.). In some embodiments associated with dropped call, a terminal state indicating a dropped call may be associated with a fault as a dropped call was not due to a user's interaction with the user device 102 (e.g., the user device or system may differentiate between a dropped call terminal state and a successful ended/hung up call terminal state). In some embodiments, portions of the user device data or state data may be inferred from other data, such as call duration. In some embodiments, some unsuccessful termination events, such as blocked calls, may not return a fault because they were intentional by one of the parties to the call. In some embodiments, the user device may detect a mechanism of termination, such as by sensing a user input on a touch screen or other interface associated with the user device and generating a termination signal associated with an ended call or by receiving a termination signal from a second device connected over the network with the user device indicating that the second device ended the call. In some embodiments, a fault may be an unexpected or error state encountered by the user device 102. In various embodiments, the system may determine if the indication of a fault was associated with a network-specific fault or with a user device-specific fault, which may be based on a determination of one or more indications as to why the fault occurred. Depending on if a fault is indicated and/or the type of fault, the user device 102 may adjust the classification or filtering of the user device data in the user device data object.

In some embodiments, such as, but not limited to, with monitoring calls and other network events, including transmissions, prior to generating a user device data object, one or more metric data may be directly measured and/or determined by the user device, including by a software application operating thereon, which metric data may be included in the user device data object. The metric data may be based on one or more of the user device data stored during operation 404. The metric data may further be based on historical user device data, which may have been stored from one or more prior calls or other operations, including transmissions, of the user device. In some embodiments, metric data may comprise numerical measures or calculations associated with user device performance (e.g., signal strength, latency, etc.). In some embodiments, the metric data may be associated with one or more performance ratings associated with one or more calls or, alternatively, a cumulative performance rating of user device 102 for all calls or calls over a time period. A performance rating may, for example, be indicative of call quality, which may be directly determined if an application is given permission to monitor or listen to a call or indirectly determined based on one or more types of user device data. In some embodiments, a performance rating of call quality may be a value (e.g., 7 out of 10) and/or a binary assessment (e.g., pass/fail). In some embodiments, the performance rating may be based on signal strength, call states (e.g., no dropped call states), power used during the call, and latency. In some embodiments, the performance rating may be generated and/or compared to an initial training data set based on objective or subjective data determining “acceptable” versus “unacceptable” performance as set by one or more users. Based on a threshold calculated from the subjective or objective criteria for “acceptable”, the user data associated with the training data may then be used to identify the performance rating for a new set of user device data. In some embodiments, the performance rating may be a calculated estimate of a quality of the network event based on the aforementioned calculations. The performance rating may further be associated with a confidence level, which may be indicative of the confidence in the performance rating being accurate. In some embodiments, if the confidence level is below a threshold then the performance rating may be disregarded. If the confidence level exceeds a threshold then the performance rating may be utilized. Additionally, or alternatively, the confidence level may be associated with a range in which the performance rating is understood to be accurate (e.g., within one sigma, two sigma, etc.). In various embodiments, a metric data may be used to indicate fault or a performance degradation, which may trigger the generation of a user device data object for transmission.

In some embodiments, one or more metric data may be indirectly indicative of one or more aspects of call performance, which may include, but is not limited to, call quality. For example, a call may not be listened to directly to determine call quality as a user would experience. Thus one or more call metrics may be used to indirectly determine call quality. In some embodiments, metric data may be included as part of a user device data object. In some embodiments, the one or more metric data may comprise indirect data associated with the user device hardware and/or software performance without including any user communication content. For example, the metric data may comprise one or more of signal strength data, latency, and the like at one or more times and/or locations (including tower ID, network ID, etc.).

At operation 410, the user device 102 transmits the user device data object. In various embodiments, the user device 102 may transmit the user device data object to a device information system 120 and/or a network information system 130.

At operation 412, a user device data object may be displayed to a user, such as on a display 212. The user device data object may be displayed at the request of a user, such as through an application operating on the user device 102, which may display some or all of the user device data object, such as in one or more dashboards. A user of a user device 102 may be able to inspect the user device data in the user device data object to inspect the performance of their user device 102, including any call metrics or performance ratings. In some embodiments, a user having experienced what the user believes to be, for example, poor call quality may evaluate data associated with their call on the display of their user device 102, including one or more call metrics associated with the user device 102 as described herein. Additionally, in some embodiments, the user data may be timestamped and the user may inspect the data according to the timestamps, which may allow a user to determine when call performance may have degraded and when issues leading to a fault may have begun. In some embodiments involving changing network towers 110, the time stamps may assist a user in evaluating when a new network tower 110 was used for an existing call.

In various embodiments, the user device 102 may classify and filter data stored and/or used to generate a user device data object. For example, the user device 102 may classify and filter phone call data and location, which may include identifying redundant data and filtering out redundant data. In various embodiments, location data may include a GPS location of a user device 102 and phone call data may include location data of the user device 102 at a state change associated with the phone call and, thus, there would be redundancy. The user device 102, identifying this redundancy, may filter out one or more of these data in order to reduce the total amount of data processed and stored. Additionally, or alternatively, the user device data may be classified as data associated with a call and data not associated with a call, and a filter may be used to exclude data not associated with a call (e.g., Wi-Fi settings data for calls over 5G networks).

In various embodiments, a user device 102 may also determine latency between states changes and/or changes in data field values. In an example, latency may increase if an increase in network traffic resulted in a user device 102 received data over longer intervals. The reduced data may, depending on the application (e.g., video call, etc.), be associated with a network-specific issue, which may or may not be a fault. If, in an example of a video call, the video call was dropped, this may be considered to be an indication of a network-specific fault. If, however, latency associated with network operations was consistent, an issue with a video call experienced by a user may be due to, for example, multiple applications running on the user device 102 that are competing for user device 102 resources. In some embodiments, latency may be calculated based on time stamp information and transmission information (e.g., time between a time stamp associated with user device data and the processing and/or transmission of that data, when accounting for predetermined delays in reporting).

In an exemplary embodiment, a user may be carrying their user device 102 and the user device 102 may be available for a call. In receiving the call, the user device may change state from available to ringing, and the user device 102 may identify the change in state. In response to the change in state, the user device 102 may collect and store user device data associated with the call. In some embodiments, this same type of user device data may be collected at each state change associated with the call. In some embodiments, different types of user device data may be collected depending on the particular state change (e.g., location data may be collected at a beginning and end of the call but not at any intermediate point). On determining a terminal state associated with the call, the user device 102 may generate a user device data object that includes this data. In generating the user device data object, the data collected and stored may be classified and filtered by the classification, which may remove redundant data or unrelated data. For example, in some embodiments, signal strength data, location data (including physical location data, such as GPS or cell tower triangulation, or network ID data, such as tower ID), and/or call type data (e.g., Wi-Fi, cellular, etc.) may be collected at each state change or a subset of the state changes during a network event. In some embodiments, metric data, such as signal strength or latency, may be used as a variable for training a model. In some embodiments, data about the time, place, or circumstances of the network event, such as location data, tower identification data, and/or call type data (e.g., cellular, Wi-Fi, etc.) may be collected at some or all of the state changes and may be used to differentiate data sets and/or narrow the source of a fault.

In some embodiments, the user device data object may be transmitted by the user device to a system following the terminal state. In some embodiments, the user device data object or multiple discrete user device data objects may be transmitted by the user device to a system at each state change or at any interval or trigger during a network event, including in real time or near real time. In some embodiments, the user device data object or multiple discrete user device data objects may be transmitted by the user device to a system on a schedule. In an example of a successful call, the user device 102 may transmit user device data objects to a device information system 120 on a schedule. In an example of a dropped call, which may be indicative of a fault, the user device 102 may transmit the user device data object in real-time or near real-time once the user device data object has been generated.

The user device data object may include a user device data summary in addition to the user device data. In some embodiments, a “summary” may include renderable or otherwise presentable data comprising some or all of the raw or processed data being summarized and/or a second-level analysis thereof. The user device data summary may include an identification of the fault as well as data and/or pointers to data used to determine the indication of the fault. Such a summary may assist in identifying to the device information system 120 the data that specifically led to the determination of an indication of a fault by the user device 102. In some embodiments, a summary may include metadata. In some embodiments, the number of dropped calls, blocked calls, and successful calls by the user device 102 since a prior time period. A time period may be defined by an amount of time (e.g., a day) or by the time since a prior state (e.g., airplane mode) or prior action (e.g., reboot). In various embodiments, the user device data object may be comprised only of the user device data summary. Alternatively, the user device data object may be comprised only of the user device data without a summary.

In some embodiments, the performance rating or other elements of the user device data may be indicative of a health of the user device or the network. The system may be configured to compare adjacent data from different devices, different access points (e.g., towers), different networks, different data points (e.g., call type), to prepare a summary of the health of the various components of the network, including the user devices. In some embodiments, the health summary may comprise an indication of a fault with the network (e.g., including a portion thereof) and/or the user device via the identification algorithms described herein.

A determination of an indication of a fault may be used to troubleshoot a network, and the indication of a fault may also determine how, when, and what data might be provided to a network information system 130. A determination of an indication of fault may occur at a user device 102, at a device information system 120, or at a user device 102 and at a device information system 120.

A determination of an indication of a fault may determine a fault to either be user device-specific or network-specific (e.g., not user device-specific). In an embodiment where the indication of a fault determines a network-specific fault, the device information system 120 may generate and transmit a fault summary to a network information system 130 in order for a network operator to troubleshoot the network 100. In an embodiment where the indication of a fault determines a user device-specific fault, the device information system 120 may generate a fault summary but may or may not transmit the fault summary to the network information system 130. Additionally, or alternatively, for a user device-specific fault, the device information system 120 may transmit an electronic communication to the user device 120 with an advisory regarding one or more actions a user may take to improve their user device performance.

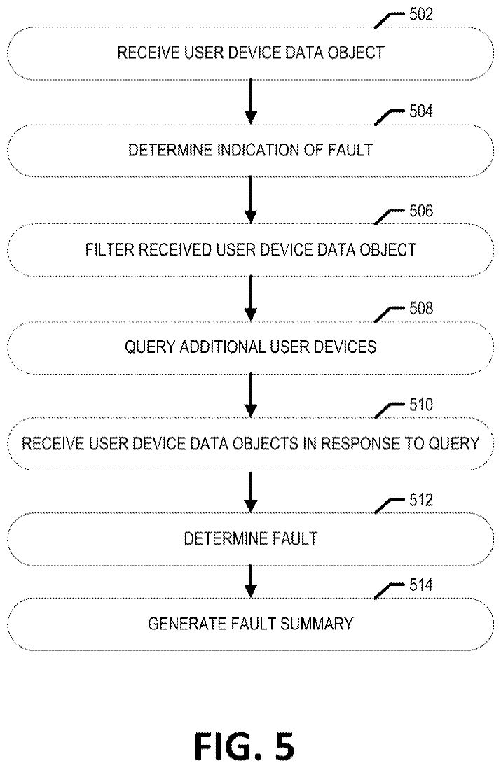

FIG. 5 illustrates a flowchart according to an example method for generating a fault summary, which may be generated at the device information system 120.

At operation 502, device information system 120 may be received a user device data object. In various embodiments this user device data object may be received from a first user device 102A.

At operation 504, device information system 120 may determine from the received user device data object an indication of a fault. If the user device data object did not include an indication of fault, the device information system 120 may determine an indication of a fault as described herein. In an embodiment in which the user device data object included an indication of a fault, the device information system 120 may identify the data in the data object indicating the indication of a fault and further identify the indication of a fault determined by the first user device 102A. Additionally, or alternatively, the device information system 120 may confirm the indication of fault by determining an indication of a fault based on the user device data received, which may confirm the indication of a fault received from the user device data.

In some embodiments embodiment in which the user device data object did not include an indication of a fault, the device information system 120 may determine an indication of a fault based on the user device data included in the user device data object. The user device data object may include classifiers associated with the user device data, and the device information system 120 may use the classifiers to identify relevant data to make the determination. In various embodiments, this may include locating and selecting one or more types of user device data to use with one or more machine learning models used to determine indications of faults.

In an embodiment in which the user device data object includes an indication of a fault, the device information system 120 may either confirm or independently determine an indication of fault. The device information system 120 may include additional analysis tools and greater amounts of data than the user device 102, and these may allow the device information system 120 to verify or determine the indication of fault. For example, in some embodiments, a user device 102 may include one or more predictive models and/or algorithms to determine performance and/or a fault, which may be less comprehensive than more robust predictive models, algorithms and/or machine learning models available to the device information system 120. For example, the predictive models and algorithms on the user device 102 may be older or may be tailored to a specific make and model of user device while the predictive models, algorithms and/or machine learning models on the device information system 120 may be current, may address an entire network, and may address additional makes and/or models of user devices.

In some embodiments, a confidence level may also be used in determining an indication of a fault. The determination of the indication of a fault may be associated with predictive models, algorithms and/or machine learning models, which may confidence levels based on the type and/or quantity of user device data utilized in determining the indication. In some embodiments, the confidence level may be based on the make and/or model of the user device as some user devices 102 may be associated with generating one or more false positives with respect to indication of faults, which may be due to the equipment in a user device 102, including the sensitivity of the equipment. Additionally, a confidence level may be associated with the age or use of the user devices 102. User devices that are older or have higher usage may be associated with different confidence levels than newer devices. The confidence level may also be used with a confidence threshold, and how the confidence level compares to the confidence threshold may be determinative if an indication of a fault is used. In some embodiments, if a confidence level exceeds a threshold than the indication of a fault may be used. Alternatively, in some embodiments, the confidence level may be associated with a probability of an error and, thus, the confidence level may need to be under or fall under a confidence threshold.

At operation 506, having determined an indication of fault, the device information system 120 may filter the received user device data object. The filtering may include identifying data types and/or data fields associated with the indication of the fault. This may also identify additional data that may be required or desired to determine if one or more faults are present.

At operation 508, additional user devices 120 may be queried to provide additionally user device data objects. The additional user devices 120 may provide additional user device data allowing for the diagnosing or troubleshooting of an area wide network, including determining if a network-specific fault is present or if the user device associated with the indication of a fault is experience a user-device specific fault. In some embodiments, querying additional user devices may comprise transmitting a signal to one or more additional user devices and receiving at least some user device data from the one or more user devices. In some embodiments, user device data for the additional user devices may be stored in a database in relation to past transmissions from the additional user devices, and the querying may be of the database.

In some embodiments, the multiple user devices 120N operate as a mesh network of data gathering devices that provide indications to determine or validate the health and performance of a wide area network, including if a fault is or degraded performance is being experienced by a user and how widespread the problem is among a group of users. Based on the data provided by each device and a comparison thereof, such as by a machine learning model, the device information system 120 may be configured to determine health information, including but not limited to a fault, associated with the network.

In various embodiments, the additional user devices 102 to query may be based on one or more data types associated with each of the additional user devices 102. The data associated with these additional user devices 102 may have been transmitted to the device information system 120 in user device data objects previously transmitted, such as in real-time or batch schedule. These user device data objects, once received, may be stored in memory of the of the device information system 120 or in an associated database that may be queried by the device information system 120. The database may be queried for data based on the information filtered in operation 506, including specific user device data associated with the indication of fault.

In various embodiments a query may be an electronic communication to each of the additional user devices 102 requesting a user device data object be transmitted to the device information system 120. The query may also include a request for specific types of data to be transmitted in response to the query. In various embodiments, the query may be an electronic communication to one or more databases, such as a memory 204 associated with the device information system 120 and/or a memory 304 associated with the network information system 300.

In some embodiments, the multiple user devices 120N acting a mesh network of data gathering devices may allow for the device information system 120 to query one or more of the multiple user devices 120N, or database data associated therewith, for current and historical data to further analyze network performance as experienced by a user.

At operation 510, the device information system 120 may receive user device data objects from the additional user devices 102N in response to the queries transmitted in operation 508. The additional user device data objects may include only data queried for or may include additional user device data, such as prior summaries indicating if any faults were experienced or any call metric data associated with poor performance.

At operation 512 a fault may be determined. The determination may be that there is a network-specific fault, that there is a user device specific fault, or that there is no fault. A determination may be made based on the user device data object and the additional user device data objects. In various embodiments, the determination of a fault may further be based on historical user device data previously received in user device data objects from prior time periods, which may have had the received user device data stored at the device information system 120 or in one or more databases.

In various embodiments the determination of a fault may be determined from user device data being aggregated from a plurality of user devices as described herein. In some embodiments, user device data from a plurality of user devices may be aggregated and used with one or more processes described herein in real time or near real time to generate meaningful, timely insights about health and fault information. In some embodiments, an aggregated value may be determined based on the user device data aggregated from the plurality of user devices. In some embodiments, the determination of a fault may be based on the aggregated value exceeding a threshold, which may be related to the performance of a network and/or performance of one or more makes and/or models of user devices (e.g., average performance ratings for a delineated group of user devices, networks, and/or locations). In various embodiments, aggregation may include averaging data, including averaging data over time and/or running averages, which may be over a time period (e.g., in the last hour, since last network tower 110 upgrade, etc.). As used herein, “average” shall include either mean or median values or both. Additionally or alternatively, the determination of a fault may be by determining distinctions between the user device data to identify instances where the network is not performing to a threshold and/or may be determined by application of a machine learning.

In some embodiments, indicators of a fault may be determined by a machine learning model, such as by using structured learning in which training data with labels (e.g., device and/or network data affirmatively marked as faulty) may be fed into an algorithm to generate a model to recognize the faults. In some embodiments, the machine learning model may identify the data points determinative of a fault.

In an example of an indication of a network-specific fault received from a user device 102A, the indication of a network-specific fault may be identified based on a dropped call experienced by user device 102. The user device data object received from user device 102A may include, among other things, user device make, user device model, network tower identification (e.g., 110A), network identification, network signal strength, and location data along with an indication of the dropped call. These data fields may be used and/or filtered from the user device data object for use by the device information system 120. The data fields may include any of the user device data described herein.

In some embodiments, the device information system 120 may use the filtered data fields to identify additional user devices with the same or similar user device makes and user device models that were on the same network having the network identification and were utilizing the same network tower with the network tower identification and within a threshold distance of the location identified in the location data (e.g., 1 mile). With reference to FIG. 1, on identifying additional user devices 102B and 102C, the device information system 120 may query user devices 102B, 102C for additional data. In response user devices 102B, 102C may transmit user device data objects that include the requested user device data. On receipt of the additional user device data objects from user devices 102B and 102C, the device information system 120 may extract the network signal strength experienced by user devices 102B, 102C when utilizing the same network as user device 102A and connected to the same network tower. In this example, the signal strength experienced by user devices 102A, 102B, and 102C may be averaged to determine if the signal strength from the network tower is below a threshold to determine that there is a network-specific fault associated with the network tower 110A. In embodiments utilizing historical data or data otherwise stored in a database, the system may query location or other filtering data associated with a time associated with collection of the data.

Additionally, in this example, the device information system may determine that the average signal strength is above a threshold for the additional user devices within the threshold distance (e.g., 1 mile) and proceed to shrink the threshold distance to a second threshold distance (e.g., ¼ mile) to determine if a network-specific fault is related to a geographic area or other location-based criteria, such as network tower ID, substation ID, or another infrastructure-based delineator. The device information system 120 may again identify additional user device data associated with the smaller geographic area define by the location data associated with user device 102A and the second threshold distance. In addition to querying additional user devices, the device information system 120 may filter previously received historical user device data. On receiving or filtering user device data associated with the revised query, the device information system 120 may determine that the network tower 110A provides service below a threshold within a geographic area. This may be identified as a network-specific fault where service is not being provided.

In various embodiments, the device information system 120 may further use data associated with specific applications being run a specific times in addition to geography and network towers. In an example, an application may require a large amount of bandwidth to stream continuous data to the device information system, including bandwidth that may exceed what a network tower 110A may be available to provide a user device 102A or that may otherwise cause negative performance of the user device, the network tower, and/or the device information system to process. In some embodiments, in experiencing a fault, including poor service, the failure of the application, and/or a dropped call, the user device 102A may provide an indication of a fault in real time to the device information system 120 to expedite delivery of the fault-related user device data. In some embodiments, the device information system may filter the received user device data object for data field it may query from additional user devices 102B, 102C that are also on the same network utilizing the same network tower 110. The device information system 120 may query and receive user device data objects from the additional user device 102B, 10C. The device information system 120 may, based on the user device data received, determine that there is no fault that is network-specific but, instead, determine that the indication of a fault is associated with a user device. In some embodiments, the device information system 120 may further diagnose the fault with the user device by comparing and identifying patterns between other user devices that have experienced or are experiencing a similar fault after determining that there is no pattern that would allow the conclusion that the fault is network-specific. The user device-specific fault may be determined to be the user device using one or more application that interfere with performance of the user device on the network, a hardware fault with the user device, or any other fault.

In various embodiments, a determination of a fault may include determination of events surrounding or related to the indication of the fault. In an example, the determination may include when or how often a user device was put into or taken out of airplane mode. In another example, the determination may determine the sequence of states experienced by a user device 120 before the determination of the indication of a fault. In another example, the determination may be further based on latency of signal transmitted to and from a network tower 110 in view of time stamps associated with the transmissions, which may indicate trends of increased latency over time or latency around particular device events. Such determinations may, to the extent they do not indicate fault, for example by not exceeding a threshold (e.g., high threshold or low threshold), may also be used for determining network health, which is further described herein.

At operation 514, the device information system 120 may generate a fault summary. A fault summary may include an indication of one or more faults experienced by one or more user devices 102. The fault summary may additionally include user device data used to determine the fault, including user device data from multiple user devices 120N.

On determination of a network-specific fault, the fault summary may be transmitted by the device information system 120 in real-time. Alternatively, or additionally, the fault summary may be transmitted on a schedule, which may or may not also be based on triggers. In an example of a schedule, fault summaries may be transmitted each day at a specific time (e.g., 2 am). In another example, fault summaries may be transmitted each day in a time period (e.g., between 2 AM and 4 AM) and also when network traffic may be determined to be below a threshold. In another example, fault summaries may be transmitted once a certain number of fault summaries have been reached or a fault summary addresses a certain number of faults. Additionally, or alternatively, the transmission may be a trigger associated with a fault associated with a specific tower or specific make and model of user devices. Additionally, or alternatively, an electronic communication may be generated and transmitted to the network information system or another recipient device indicating the fault and providing a recommendation to resolve the fault based on the particular fault identified and/or based on patterns between the devices, network(s), and/or portions of network(s) (e.g., towers) experiencing the fault.

On determination of a user device-specific fault, a fault summary may similarly be transmitted in real-time or based on a schedule, such as to the user device 102, network information system 130, or another recipient device. Additionally, or alternatively, an electronic communication may be generated and transmitted to the user device 102A indicating the fault and providing a recommendation to resolve the fault based on the particular fault identified and/or based on patterns between the devices experiencing the fault. In an example, the electronic communication may be through an application that indicates that user device 102A may need to be updated to a new software version in an instance in which only devices having the old software version experienced the fault. In another example, the electronic communication may be an email to the user of the user device 102A that recommends the user be aware of the data usage of multiple applications operating simultaneously. In another example, the electronic communication may be through an application to provide a direct message (e.g., push notification, text message, etc.) that the user device 102A is experiencing a slow down or may be optimized by closing one or more applications. In another example where a user may have opted in for an application to have permissions to modify the device, the electronic communication may be a transmission to the user device 102A to close one or more applications, update application versions, and/or turn on or off one or more services or settings on the user device 102A or one or more applications.

In various embodiments, a determination of a user-device specific fault may also be made in association with the performance of the make and model of the user device 102. For example, there may be a performance difference between the hardware and software associated with an earlier user device 102A and a later user device 102B such that user device 102B is faster, receives a better signal (e.g., high signal strength), user a faster network (e.g., 5G compared to 3G) and is experienced by the user to generally perform better. While a user may not be aware of distinctions in performance of make and model of user device, the determination of an indication of a fault and determination of a fault may consider these distinctions with different thresholds, ranges, or triggers for determinations.

In various embodiments, triggers may be set by a user of a device information system 120. In various embodiments, a user setting triggering transmission allows for the device information system 120 to be tuned to monitor and identify known or suspected performance and/or fault conditions. In some embodiments, these triggers may be identified and/or monitored by a model, such as a machine learning model, in accordance with the various embodiments disclosed herein.

The fault summary may be transmitted to a network information system 130. Additionally, the data in the fault summary may be filtered, classified, and/or revised based on the network operator (also referred to as a “carrier”) that the fault summary is being transmitted to. In an example, a network operator may require that data be in a specific format or be coded in a specific manner. Further, the determination of the fault may be based on specific data or combinations of data, and the fault summary may be filtered and classified to indicate how the data being transmitted may be used by the network operator to reproduce the determination of the fault. In another example, the device information system 120 may receive data from one or more user devices 102 that user network towers 110 provided by a network operator but the users of user devices 102 may not be otherwise associated with the network operator (e.g., mobile phones roaming). In such an example, user device data may be revised, such as anonymized, before being provided to the network operator 130. In another example, the data received from the user devices 102 may be in an original data format, which may be converted to another data format that may readily be understood or interpreted by a user.

Additionally, though not depicted in FIG. 5, one or more of the operations of FIG. 5 may be repeated. For example, if at operation 512 additional user device data is determined to be needed in order to determine a fault, then the process may proceed back to operation 508. For example, during operation 512 it may be determined that additional user device data of another data type or additional user devices going back to further in time is needed, then operation 508 may be repeated to query user devices for the additional user device data. Alternatively, or additionally, additional user device data may be determined to be needed for one or more predictive models, algorithms, or machine learning models, which may be determining if additional distinct performance issues and/or faults are present. In some embodiments, user device data may indicate the possibility of multiple faults and the system may assess each.

In various embodiments, the user device data received may be used to determine call quality, such as with a mean opinion score (MOS). While a MOS is a user's subjective score, a value may be indirectly determined based on one or more data and/or data fields in the user data received. Such data may be associated with a user's experience with the call. In some embodiments, the performance rating discussed herein may be an estimate of MOS. In various embodiments, signal strength, latency, time with poor signal during a call, etc. may be indicative of a low MOS. A machine learning model, as described herein, may be used to determine if a low MOS score representing a poor call quality is network-specific or user device-specific. For example, signal strength may increase or decrease over the course of a call, latency of receiving data during a call may increase or decrease over the length of the call, time with poor signal during a call may be high for the call as compared to prior calls. In some embodiments, a machine learning model may be specifically tailored to the user of the user device 102, which may include simulating the make and model of the device as well as states experienced by the user device 102. In some embodiments, training data for the machine learning model may comprise subjective user scores of device quality (e.g., labels) combined with user device data from a network event associated with the scores.

In various embodiments, an indication of a fault may be determined not only from the current experience of a user device 102 but also from past, or historical, experiences of user device 102. An indication of a fault may be generated if a user device experiences poor performance or errors in service multiple times. In various embodiments, the experience of a pattern (e.g., multiple dropped calls) may occur before determining an if a fault is present.

The device information system 120 may receive a first user device data object from a first user device 120A and determine an indication of a network-specific fault based on the first user device data object. Based on the indication of the network-specific fault, the device information system 120 may then query a second user device for a second user device data object, such as when the device information system 120 may determine additional data would be used to confirm a fault is present. The device information system 120 may receive a second user device data object from the second user device. Based on the indication of the indication of the network-specific fault, the first user device data object, and the second user device data object, the device information system 120 may determine a confidence level. The confidence level may be associated with one or more confidence thresholds. For example, a confidence level may be in a range from 0-100. The device information system 120 may determine that the indication of a fault is with a confidence level of 95. There may be multiple confidence thresholds, and a confidence threshold of 90 may be associated with a fault being present. There may be a confidence threshold of 50, and if the confidence level is below 50 then a determination may be made that the indication of the fault should be disregarded. When the confidence level exceeds a confidence threshold, the device information system 120 may generate a fault summary and transmit the fault summary to a network information system 130. Additionally, depending on the confidence level and which confidence threshold was exceeded, the fault summary may be transmitted in real time or, alternatively, if a confidence level is below a confidence threshold then the fault summary may be transmitted on a schedule or in response to a query.

In an exemplary embodiment, the confidence level may be associated with an indication of a network-specific fault associated with a network tower 110A. A first user device 102A may have transmitted a first user device data object to device information system 120, which may include, among other things, tower identification data, location data, and signal strength. In some embodiments, the device information system 120 may query one or more additional user devices 120N for user device data, and a second user device 102B may transmit a user device data object to the device information system 120. The user device data object from the second user device 102B may include, among other things, tower identification data, location data, and signal strength. Thus the device information system 120 may have similar data and/or the same data types from more than user device 102, which may allow the device information system 120 to determine a confidence level associated with the indication of a network-fault associated with network tower 110A. If both user devices 102A, 102B experience the same or similar performance with network tower 110A then the confidence level may be high. If the second user device 102B experienced different performance with network tower 110A then the confidence level may be lower.

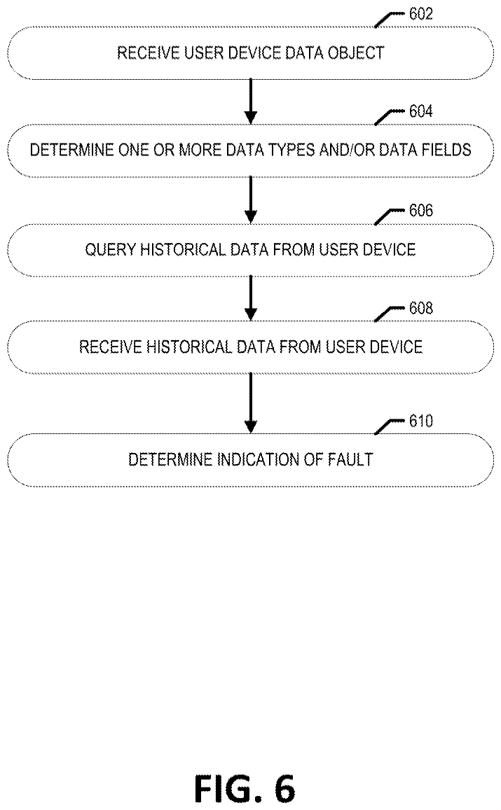

FIG. 6 illustrates a flowchart according to an example method for generating a fault indication based on historical user device data.

At operation 602, a user device data object is received from a user device 102. The device information system 120 may receive a user device data object which may have been transmitted from a user device 102 as described herein.

At operation 604, one or more data types and/or data fields are determined. The device information system 120 may determine one or more data types and/or data fields that may be evaluated to determine an indication of a fault based on the user device data object. The one or more data types and/or data fields may be associated with one or more machine learning models, algorithms, and/or predictive models.

At operation 606, historical data from a user device is queried. The device information system 120 may determine that additional historical information may be needed to determine an indication of a fault. The device information system 120 may generate a query to transmit to the user device 102. The query may include one or more data types and/or data fields for the user device 120 to transmit. The query may further include a network and/or one or more portions of a network, such as a network tower, for the data types and/or data fields to be associated with. The query may or may not be limited to a time period and/or a time of day. The query may also include one or more classifiers associated with data. The device information system 120 queries the user device 102 for historical information based on the query.

At operation 608, historical data from a user device 102 is received. In response to receiving the query for historical data from the device information system 120, the user device 102 transmits a second user device data object comprised of the historical user device data requested. In various embodiments, the historical user device data may include additional data beyond what was in the query, which may include data types associated with historical activity.

In various embodiments, a query may have requested historical data of network data and phone call data from the past week related to a specific network tower. In response the user device 102 generate a user device data object of historical user device data that also includes user device application data. This user device data object with historical user device data may be received by the device information system 120.

In various embodiments, a query may have requested historical data of network data and phone call data from the past week related to the user device's 102 experience with the entirety of the network. In response the user device 102 generate a user device data object of historical user device data that also includes user device application data. This user device data object with historical user device data may be received by the device information system 120.

At operation 610, an indication of a fault is determined. The device information system 120 may, after having received both a first user device data object at operation 602 and historical data in a second user device data object at operation 608 may determine an indication of a fault.

In various embodiments, instead of, in addition to, or as a precursor to determining the indication of fault, the device information system 120 may determine a performance rating. The performance rating may be consistent across, for example, multiple network towers, which may be indicative of a user device-specific fault. Alternatively, the performance rating may vary across network towers and a poor performance rating (e.g., 1 of 10) may be associated with a single network tower, which may be indicative of a network-specific fault.

The data from multiple user devices 120N may be used to analyze the health and performance of a network in addition to any faults. As described herein, a network information system 120 may receive user device data from multiple user devices 102. The user device data received may be aggregated to determine network performance, including to determine that there are no performance and/or quality problems being experienced, such as by a user on their user device 102. Alternatively, the user device data may be used to determine how performance may have degraded over time, including at one or more portions of equipment of the network associated with the degraded performance (e.g., a network tower 110, a board in a network tower 110, a memory in network tower 110, multiple network towers 110, etc.). One or more models, including machine learning models, may be used to determine

In various embodiments, a network health summary may be determined, which may include, but is not limited to, identifying one or more portions of a network (e.g., network tower, network node, etc.) as well as one or more performance and/or operating indicators of the network. For example, the health summary may include binary information, such as “pass” or “fail” for various network portions and/or user devices. In some embodiments, the health summary may include more granular information, such as an operating efficiency or quality metric determined by the various processes and models discussed herein. The health summary may include one or more indications of faults. In various embodiments, performance and/or operating indicators may include, but are not limited to, ratings of the performance and/or operation of one or more portions of the network, including any faults or indications of faults. In various embodiments, the network health summary may also include how a performance rating, fault, and/or indication of fault may have been determined (e.g., thresholds, determination criteria, etc.). In various embodiments, a network health summary may indicate that there are no errors and the network is operating at an optimal level, which may include quality metrics related to the determination of the operation at the optimal level.

A network health summary may be provided in addition to, or instead of, a fault summary or may include a fault summary. In some embodiments, a fault summary may be associated with a focus on one or more user devices 102 and a network health summary may be associated with a focus on the performance of the network.

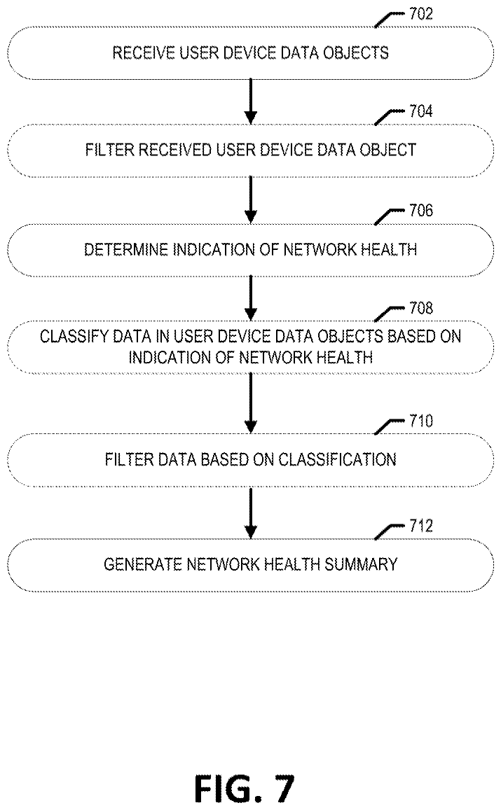

FIG. 7 illustrates a flowchart according to an example method for generating a network health summary. A network health summary may include one or more performance ratings of one or more of the portions and equipment in a network 100. Additionally, a network health summary may include one or more indications of faults associated with the network and/or portions of the network (e.g., one or more network towers 110).

At operation 702, user device data objects may be received. In various embodiments, a device information system 120 may receive a user device data object from one or more user devices 102N. In various embodiments, an application running on each of the user devices 102 may transmit a user device data object generated by the user device 102 at regular time intervals or in real-time or in near real-time as a user device 102 may experience various states.

At operation 704, the received user data objects may be filtered. In various embodiments, the device information system 120 may filter the received user device data objects in order to determine the health of the network. The filtering may be to identify and isolate data associated with one or more portions of the network (e.g., a first network tower 110 and a second network tower 120). The filtering may create one or more additional data objects that are associated with each of these portions of the network.

At operation 706, an indication of network health may be determined. The indication of network health may be based on a determination of one or more performance ratings associated with the network, which may be compared to performance rating thresholds. A performance rating threshold may be associated with one or more data types and/or data fields. The performance rating threshold may also be associated with an indirect determination of a user experience based on one or more data fields (e.g., a mean opinion score, etc.). In various embodiments, a threshold may be associated with a number of dropped calls, call quality, MOS, signal strength, successful call rate, etc. In some embodiments, the performance rating and the performance rating threshold may be determined with a machine learning model, prediction model, and/or algorithm.

At operation 708, data in the user device data objects may be classified based on the indication of network health. In various embodiments, the data in the received user device data objects may be classified based on the data types and/or data fields used in determining the indication of network health. The classifiers may be added to the data objects, new data objects may be generated that include the classifiers, and/or additional data objects may be generated that included the classifiers as pointers to data types and/or data fields in the user device data objects.

At operation 710, the data may be filtered based on the classification. The device information system 120 may filter the user device data objects based on the classifiers. The filtering may remove data not related to determination of network health.

At operation 712, a network health summary may be generated. The network health summary may be comprised of the filtered user device data based on the classifiers, the performance ratings, and/or indications of network health.

In various embodiments, if the network health summary includes a performance rating or below a threshold, the network health summary may be transmitted from the device information system 120 to a network information system 130 in real-time. Alternatively, the network health summary may be transmitted on a regular schedule.

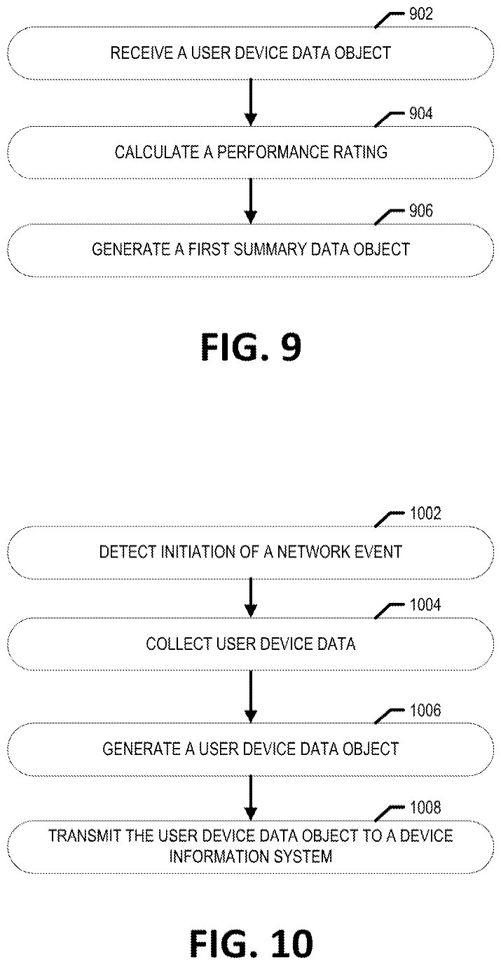

FIG. 9 illustrates a flowchart according to an example method for calculating a performance rating and generating a summary data object associated with a network event.

At operation 902, the device information system 120 receives a user device data object 902, such as from a user device. In some embodiments, the user device data object comprises user device data associated with a network event. In some embodiments, the network event comprises at least one transmission between the first user device and a second device over a network.

At operation 904, the method includes calculating, based on the user device data, a performance rating associated with the at least one transmission. In some embodiments, the performance rating may be indicative of a quality of the at least one transmission.

At operation 906, the method includes generating a first summary data object based on the performance rating. In some embodiments, the first summary data object comprises renderable data indicative of the quality of the at least one transmission.

FIG. 10 illustrates a flowchart according to an example method for generating user device data associated with a network event. The embodiment of FIG. 10 may be performed, by way of non-limiting example, by a user device.

At operation 1002, a software application operating on a first user device may detect initiation of a network event. In some embodiments, the network event may include at least one transmission between the first user device and a second device over a network.

At operation 1004, the software application may collect user device data associated with the network event during the network event. In some embodiments, the user device data is indicative of a performance rating associated with a quality of the at least one transmission.

At operation 1006, the method may include generating a user device data object comprising the user device data associated with the network event.

At operation 1008, the method may include transmitting the user device data object to a device information system.

In some embodiments, any of the methods described herein may be performed by one or more systems, including various user devices, servers, and the like.

### Example Machine Learning Processes

In various embodiments, network performance, network health, and/or faults, such as a network-specific fault or a user device-specific fault, may be determined with machine learning. Various types of machine learning may be used, including but not limited to supervised learning, unsupervised learning, and reinforcement learning. In some embodiments, any type of modeling may be used.

Such machine learning models may be subjected to and/or implement unsupervised training, supervised training, semi-supervised training, reinforcement learning, deep learning, and/or the like in order to analyze user device data and in turn, determine and utilize relationships for such user device data for fault detection, device analysis, and network analysis according to the various embodiments herein. During training of such a machine learning model (e.g., artificial/convolutional neural network or the like), the model may be iteratively supplied with a plurality of user device data such that the model may be configured to, over time, determine patterns amongst the plurality of parameters, values, and data points defined by the data. Said differently, the machine learning model may be configured to determine a correlation or pattern associated with the values and parameters within the user device data so as to determine a more accurate prediction of health and/or fault information.

In various embodiments, a machine learning model may be trained to address an entire network. Alternatively, instead of addressing the entire network at once, a machine learning model may be trained to address a specific network node, a specific portion of a network (e.g., multiple network towers 110N, such as those along a common route), or a specific portion of network equipment (e.g., a single network tower 110). In various embodiments, what the machine learning model addresses may be based on the training data sets that may be used to train the machine learning model. Moreover, a model, including machine learning models, may be created and/or trained to identify and classify relevant subgroups of a network, which may define inflection points and groupings of portions of the network and/or user device groups around which the data is consistent and generally representative and indicative of the group (e.g., within a predetermined confidence level).

In various embodiments, a machine learning model may address data associated with a single tower in order to account for distinctions of the single tower compared to other towers in the network. Such distinctions may allow for the determination of performance, health, or faults to take into account, for example, the physical topology that the single tower addresses (e.g., surrounding buildings, hills, mountains, forests, power lines, etc.). In various embodiments, such topology may be accounted for in the machine learning model by including, among other things, location data in the training data set. In various embodiments that also include signal strength data, such training data sets may train the model to address signal strength at different locations for individual network towers. In various embodiments, the usage of a machine learning model of one network tower, as opposed to the entire network, may allow for filtering out of data not relevant to the analysis of a single network tower.

In various embodiments, a machine learning model may address a network, including the network's nodes, portions, and equipment. The analysis of the entire network may allow for determining of any network wide issues in case any portion of a network has poor performance, network health, and/or faults. In various embodiments, the usage of a machine learning model of a network may omit duplicative data that may be common as to multiple network towers. In embodiments addressing a network, the machine learning model may compare performance, health, and/or faults for the various network equipment across the network. As such, the user device data to include the training data set may not be filtered for one particular tower, though filtering may apply to remove duplicative data. In various embodiments, for example, duplicative data may include location data, such as from GPS, and certain area codes. In various embodiments, the machine learning model may determine one or more portions of a network to group together to indicate poor performance, poor health, or a fault.

In various embodiments, a machine learning training data set may include historical user device data from one or more user devices 102. The historical user device data may also be from a different network and/or a different type of network. The machine learning model may include reinforcement learning, and it may continue to learn as additional current user device data is provided, including how to address the current network. The various machine learning models may be trained based on data collected from user devices according to the various methods, software, and hardware described herein.

In some embodiments, a machine learning model may be generated and run in association with a manufacturer, a make, and/or a model of a user device 102. In such embodiments, the machine learning model may exclude data related to other makes and/or models of devices. For example, as a make and model of a user device by a manufacturer may be aging compared to current user devices 102 and current networks and, thus, may have reduced performance, a machine learning model may be associated with a profile for the older make and model to determine any performance or fault issues occurring due to the aging user device 102 as opposed to the network 100. The user device data used with this machine learning model may be filtered for the particular manufacturer, make, and model of the user device 102. Such machine learning models may allow for the device information system 120 to generate profiles or build profiles to analyze and predict performance, health, and/or faults as a user may experience due to their user device 102 while using a network 100.

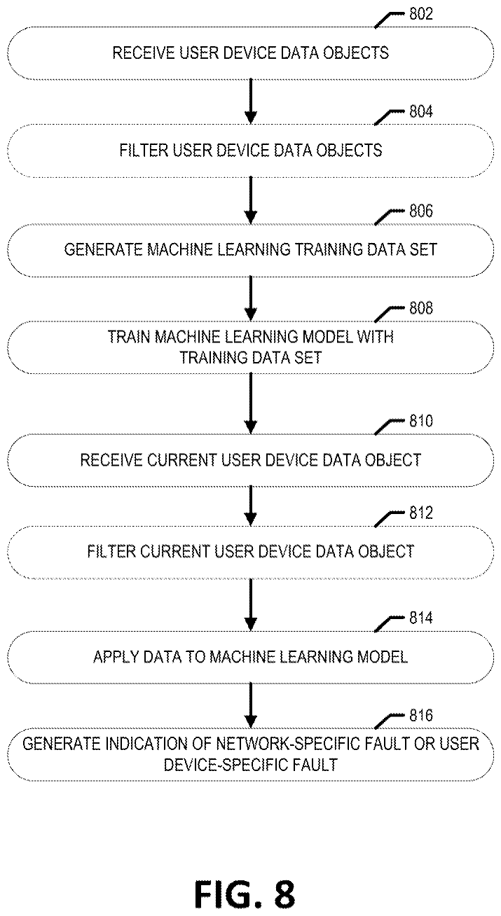

FIG. 8 illustrates a flowchart according to an example method for generating an indication of a network-specific fault or user device-specific fault, including by using a machine learning model. In various embodiments, the operations illustrated in FIG. 8 may also be used to generate a performance rating or network health rating instead of an indication of fault.

At operation 802, the device information system 120 receives one or more user device data objects. In various embodiments, the user device data object may be current data (e.g., current user device data objects) or may be historical data (e.g., historic user device data objects). Historical data may be kept in one or more databases and/or may be queried from one or more user device 102, such as described herein.

At operation 804, the user device data objects may be filtered. In various embodiments, the machine learning model may be associated with a specific piece of network equipment and one or more the user device data objects received may be filtered to exclude data no relevant to the one or more pieces of equipment. For example, data not related to a first network tower may be filtered out. As an alternative example, data not related to the network type (e.g., 5G, Wi-Fi, etc.) may be filtered out.

In any of the various examples of filtering discussed herein, the filtering (if any) may be performed to the extent necessary to generate a useful data set. In some embodiments, filtering may not be required or may be done in advance. In some embodiments, the filtering of data may be to only include data consistent across user devices 102. There may be multiple makes and models of devices from multiple manufacturers, and the user devices 102 may not provide the same data. Moreover, in some embodiments with a machine learning model directed to a profile having a specific make, model, and/or manufacturer, specific data fields available may be known or specified. In various embodiments, the data available to be used may be further limited by permissions a user has or has not given to an application running on the user device 102, which may restrict the availability of user device data. The filtering may filter out any user device data not relevant to the machine learning model.

In some embodiments, the filtering may anonymize the user device data. The filtering may remove any user IDs or data that may be used to specifically identify a user. In various embodiments, this may also include remove a user ID or data used to specifically identify a user and replacing it with other data (e.g., a record indicator) that may not be used to identify a user. In some embodiments, the software running on the user device may only collect anonymized data and/or may pre-filter the data for anonymization prior to being transmitted as a user device data object to the device information system.

At operation 806, a machine learning training data set is generated. The filtered data may be used to generate a training data set. The training data set may be a subset of the filtered data, such as by removing indications of performance, health, or faults to leave other data that would not be used by the machine learning model to directly provide what the device thought was, for example, a fault. This may be due to a fault being determined by one make or model of a user device 102 where what this user device 102 recorded as a network specific-fault was actually a user device-specific fault.

In some embodiments, a machine learning training data set may be a portion, or multiple portions of the overall filtered user device data, such that each portion may be used to train and/or verify the machine learning model. For example, a first portion may comprise 95% of the filtered user device data and a second portion may comprise 5% of the filtered user device data, which may be used to verify the machine learning model.

In an exemplary embodiment, a first portion of the filtered user device data may be a training data set and a second portion of the filtered user device data may serve to verify the machine learning model. After the machine learning model has been trained, such as at operation 808, the second portion of filtered user device data may be applied to the machine learning model to verify the machine learning model's results with known data (e.g., a test data set).

At operation 808, a machine learning model is trained with the training data set. In various embodiments, a machine learning model may be supervised or unsupervised. The machine learning model may have the filtered user device data, or one or more portions of the filtered user device data, applied to the machine learning model. After the machine learning model has had the training data set applied, the machine learning model may be ready to receive current user device data.

In various embodiments, after machine learning model has been trained with the training data set, the machine learning model may identify one or more data types and/or data fields that are relevant to the determine and/or generate an indication of performance, health, and/or faults. The identification of relevant data types and/or data fields may also, conversely, identify data types and/or data fields that are not relevant or that have sufficiently low relevance that they may be excluded from application to the machine learning model. Such data types and/or data fields may be used to filter data as described herein. Future filtering processes may exclude these irrelevant/low relevance data fields from the received user device data objects for better model performance. For example, modeling, including machine learning, may be applied to one or more of the data fields associated with the user device data identified herein. The modeling may indicate critical and irrelevant variables for generation of one or more final machine learning models.

At operation 810, a current user device data object is received, such as from a first user device 102. In various embodiments, a current user device data object may be received by a device information system 120 from a user device 102A on network 100, such as described herein. In some embodiments, a user device data object including current user device data and historical device data may be used in the process herein.

At operation 812, the current user device data object may be filtered. In various embodiments, not all data received in the current user device data object may be relevant to the machine learning model, and the device information system 120 may filter the data in the current user device data object to remove any data that is not relevant. In an alternative embodiment, the filtering may be done prior to transmission of the current user device data object. In a further alternative embodiment, the user data object transmitted from the user device 102A may already have been filtered and then this received user data object may be further filtered for application to this specific machine learning model, which may be one of multiple machine learning models that the data in the user device data object may be applied to.

At operation 814, the filtered data of the current user device data object is applied to the machine learning model. In alternative embodiments not illustrated, the current user device data object may not be filtered.

At operation 816, an indication of a network-specific fault or a user device-specific fault is generated, which may be based on the filtered data of the user device data object. In various embodiments, an indication of a network-specific fault may indicate that there was a fault with a particular network tower. In various embodiments, a user device-specific fault may indicate that there was a fault with a user device 102A, such as one or more applications causing a fault on the user device 102A, which may have led to, for example, a dropped call or poor call quality.

In an exemplary embodiment, a machine learning model be based on a profile related to how many times a user device 102 toggled modes that would turn off network connectivity (e.g., airplane mode) as well as utilized one or more applications that may turn on or off network connectivity to determine network performance. Historical user device data objects may be used to train a machine learning model to evaluate this profile. Historical user device data objects may be gathered from one or more user devices 102N, such as described herein, or from a database storing historical user device data objects. The historical user device data objects may contain data associated with successful calls having good network performance (e.g., data in one or more data fields above one or more thresholds associated with each data fields) as well as fault and/or poor network performance. The historical user device data objects may be filtered for data not relevant to the profile. The filtered data may be a training data set applied to the machine learning model to train the machine learning model to determine relationships between data fields and performance and/or faults in the network. The current user device data object may then be received, filtered, and applied to the machine learning model to generate an indication if a user is experiencing poor performance and/or a fault associated with their user device 102 is network-specific or user device-specific.

In various embodiments, the machine learning model be used to generate and/or revise one or more algorithms and/or prediction models. The algorithms and/or prediction models may be transmitted to a user device 102 and may be applied by the user device 102, such as by an application, that may be used to determine if a fault is network-specific or user device-specific. In various embodiments, revisions may include if or how an algorithm and/or prediction model applies to one or more make and/or models of user device 102, which may include adding or removing one or more data types or data fields to the algorithm and/or prediction models.

In an exemplary embodiment, a first user may use a user device 102A of an iPhone 4, which may be a comparatively older make and model of a user device 102A. The user may experience what the user perceives as performance, such as with poor call quality, which may include a dropped call. The user device 102 may, on a trigger, such as a dropped call, after each call, or based on a schedule, generate, and transmit a user device data object to a device information system 120. The device information system 120 may identify that the user device 102A is an iPhone 4 and generate a profile based on this make and model to determine if the poor performance and dropped call is user device-specific or network-specific. The model may be trained using historical user device data received from multiple user devices 102. Additionally, the device information system 120 may querying additional user devices 102 for additional user device data objects related to the profile. The device information system 120 may add classifiers to each of the user device data objects to improve the ability to locate relevant data types or data fields. These classifiers may include one or more profile identifiers associated with the machine learning model and/or the profile associated with the machine learning model. The training model is trained on the relevant data according to the various embodiments discussed herein. The machine learning model may then have the current user device data from the user device 102A of the iPhone4, which may be filtered before being applied. The machine learning model may then be used to, for example, determine that the performance of the user device 102 was user device-specific, such as with an older user device 102 being used on a modern network not operating with the performance a user desires. In various embodiments, the results of the machine learning model may be displayed on the user device 102A to inform the user of the performance, which may be compared to performance of other devices, which in some embodiments may be the same make and/or model or may be an average of makes and/or models using the network.

In various embodiments, the machine learning model may further determine one or more recommendations and generate an indication of the recommendation, which may be displayed on a user device. For example, a user device may display the indication of the recommendation via an application. This application may prompt a user of a user device to change one or more settings, such as closing one or more applications as well as turning on or off a setting. In various embodiments, the application may request permission to make one or more modifications to the user device and, upon receiving permission from a user, the application may make the changes (e.g., switch networks from 5G to Wi-Fi, update one or more applications, close an application, etc.). In various embodiments, in which one or more settings of a user device 102 was determined to be associated with poor performance or an indication of a fault, on further experience of the poor performance or indication of a fault, multiple iterations of the machine learning model be performed, with the iterations removing one or more data or data fields from the model.

Additionally, in various embodiments, the device information system 120 may, based on the determinations made by the machine learning model, generate one or more indications of repairs. If a user device 102 is determined to have a device-specific fault associated with one or more portions of the user device 102, then an indication of a repair to be made may be generated. For example, if a battery was determined to periodically fail, there may be an indication that the battery needs to be repaired.

### CONCLUSION

Although exemplary embodiments have been described above, implementations or embodiments of the subject matter and the operations described herein can be implemented in other types of digital electronic circuitry, computer software or program, firmware, or hardware, including the structures disclosed in this specification and their structural equivalents, or in combinations of one or more of them.

Embodiments of the subject matter described herein may be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The processes described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

The term “data processing apparatus” as used above encompasses all kinds of apparatus, devices, and machines for processing data, including by way of example a programmable processor, a computer, a system on a chip, or multiple ones, or combinations, of the foregoing. The apparatus may include special purpose logic circuitry, e.g., an FPGA (field programmable gate array) or an ASIC (application-specific integrated circuit). The apparatus may also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment may realize various different computing model infrastructures, such as web services, distributed computing, and grid computing infrastructures.

Computer software or computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A computer program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method comprising:
receiving, at a device information system from a first user device, a user device data object;
wherein the user device data object comprises user device data associated with a network event;
wherein the network event comprises at least one transmission between the first user device and a second device over a network;
calculating, based on the user device data, a performance rating associated with the at least one transmission, wherein the performance rating is indicative of a quality of the at least one transmission;
generating a first summary data object based on the performance rating, wherein the first summary data object comprises renderable data indicative of the quality of the at least one transmission.

2. The method of claim 1, wherein generating the first summary data object comprises diagnosing a fault with the first user device based on the performance rating, wherein the performance rating is below a threshold value.

3. The method of claim 1, further comprising:
receiving, at the device information system from a plurality of additional user devices, additional user device data objects, the additional user device data objects comprising additional user device data; and either:
(1) comparing the additional user device data associated with the plurality of additional user devices with the user device data associated with the first user device; or
(2) calculating, based on the additional user device data, an additional performance rating for each of the plurality of additional user devices and comparing the additional performance ratings for the plurality of additional user devices with the performance rating for the first user device; and
diagnosing a fault with the first user device or the network based on the comparison of (1) or (2), wherein the renderable data indicative of the quality of the at least one transmission comprises renderable data indicative of the fault.

4. The method of claim 1, further comprising:
receiving, at the device information system from a plurality of additional user devices, additional user device data objects;
comparing at least a portion of the user device data object with at least a portion of the additional user device data objects; and
diagnosing a fault with the first user device or the network based on the comparison, wherein the renderable data indicative of the quality of the at least one transmission comprises renderable data indicative of the fault.

5. The method of claim 4, wherein the portion of the user device data object and the portion of the additional user device data objects comprises one or more of location data, tower identification data, or call type data.

6. The method of claim 4, further comprising:
aggregating at least a portion of the additional user device data objects to generate an aggregated user device data object; and
generating a model based on the aggregated user device data object, wherein comparing at least a portion of the user device data object with at least a portion of the additional user device data objects comprises applying the portion of the user device data object to the model.

7. The method of claim 1, wherein the user device data comprises indirect data associated with the quality of the at least one transmission, and wherein the indirect data comprises data that does not include user communication content, such that the performance rating comprises an estimation of the quality without using the user communication content.

8. The method of claim 1, wherein the network event comprises a call between the first user device and the second device, wherein the user device data comprises user device data associated with the call, wherein the performance rating comprises a call performance rating associated with the call, and wherein the quality of the at least one transmission comprises a call quality.

9. The method of claim 8, wherein the user device data comprises indirect data associated with the call quality, and wherein the indirect data comprises data that does not include user communication content, such that the call performance rating comprises an estimation of the call quality without using the user communication content including voice signals.

10. The method of claim 1, further comprising:
causing rendering of a graphical user interface element on the first user device, wherein the graphical user interface element comprises a permission request, and
receiving a selection indication associated with the graphical user interface element of acceptance of the permission request, wherein the user device data object is received in an instance in which the permission request is accepted.

11. The method of claim 1, wherein the user device data object comprises user device data associated with one or more state changes associated with the at least one transmission, the user device data comprising data associated with the plurality of state changes.

12. The method of claim 11, wherein calculating the performance rating comprises:
identifying the one or more state changes of the user device, including a terminal state change;
determining, based on the one or more state changes and the data associated with each of the one or more state changes, the performance rating.

13. The method of claim 1, wherein the user device data comprises data indicative of one or more of signal strength associated with the at least one transmission, transmission latency associated with the at least one transmission, or a termination identifier associated with the at least one transmission.

14. The method of claim 1, further comprising:
querying a second user device for a second user device data object;
receiving, from the second user device, the second user device data object;
determining a confidence level based on the first user device data object or the performance rating and based on the second user device data object; and
in an instance in which the confidence level is above a threshold, the first summary data object comprises a fault summary associated with a fault.

15. The method of claim 14, wherein the determination of the confidence level is based at least on tower identification data, location data, and signal strength data from each of the first user device data object and the second user device data object.

16. (canceled)

17. The method of claim 14, wherein querying the second user device further comprises:
determining a location of the first user device;
filtering the location of each of a plurality of user devices for one or more of the plurality of user devices with location data within a threshold distance of the location of the first user device;
identifying the second user device for querying from the one or more of the plurality of user devices with location data within a threshold distance of the location of the first user device.

18.-22. (canceled)

23. A system comprising:
a device information system connected to a plurality of user devices via a network, wherein device information system is configured to:
receive, from a first user device, a user device data object;
wherein the user device data object comprises user device data associated with a network event;
wherein the network event comprises at least one transmission between the first user device and a second device over a network;
calculate, based on the user device data, a performance rating associated with the at least one transmission, wherein the performance rating is indicative of a quality of the at least one transmission;
generate a first summary data object based on the performance rating, wherein the first summary data object comprises renderable data indicative of the quality of the at least one transmission.

24. The system of claim 23, wherein to generate the first summary data object comprises a diagnosis of a fault with the first user device based on the performance rating, wherein the performance rating is below a threshold value.

25. The system of claim 23, wherein the device information system is further configured to:
receive, from a plurality of additional user devices, additional user device data objects, the additional user device data objects comprising additional user device data; and either:
(1) compare the additional user device data associated with the plurality of additional user devices with the user device data associated with the first user device; or
(2) calculate, based on the additional user device data, an additional performance rating for each of the plurality of additional user devices and comparing the additional performance ratings for the plurality of additional user devices with the performance rating for the first user device; and
diagnose a fault with the first user device or the network based on the comparison of (1) or (2), wherein the renderable data indicative of the quality of the at least one transmission comprises renderable data indicative of the fault.

26. The system of claim 23, wherein the device information system is further configured to:
receive, from a plurality of additional user devices, additional user device data objects;
compare at least a portion of the user device data object with at least a portion of the additional user device data objects; and
diagnose a fault with the first user device or the network based on the comparison, wherein the renderable data indicative of the quality of the at least one transmission comprises renderable data indicative of the fault.

27. The system of claim 26, wherein the portion of the user device data object and the portion of the additional user device data objects comprises one or more of location data, tower identification data, or call type data.

28. The system of claim 26, wherein the device information system is further configured to:
aggregate at least a portion of the additional user device data objects to generate an aggregated user device data object; and
generate a model based on the aggregated user device data object, wherein comparing at least a portion of the user device data object with at least a portion of the additional user device data objects comprises applying the portion of the user device data object to the model.

29. The system of claim 23, wherein the user device data comprises indirect data associated with the quality of the at least one transmission, and wherein the indirect data comprises data that does not include user communication content, such that the performance rating comprises an estimation of the quality without using the user communication content.

30.-44. (canceled)

45. A method comprising:
detecting, via a software application operating on a first user device, initiation of a network event, the network event comprising at least one transmission between the first user device and a second device over a network;
collecting, via the software application, user device data associated with the network event during the network event, wherein the user device data is indicative of a performance rating associated with a quality of the at least one transmission;
generating a user device data object comprising the user device data associated with the network event; and
transmitting the user device data object to a device information system.

46. The method of claim 45, further comprising:
calculating, based on the user device data, the performance rating associated with the at least one transmission, wherein the performance rating is indicative of a quality of the at least one transmission; and
diagnosing a fault with the first user device based on the performance rating, wherein the performance rating is below a threshold value.

47. The method of claim 45, wherein the user device data comprises indirect data associated with a quality of the at least one transmission, and wherein the indirect data comprises data that does not include user communication content.

48. The method of claim 45, wherein the network event comprises a call between the first user device and the second device, wherein the user device data comprises user device data associated with the call.

49. The method of claim 48, wherein the user device data comprises indirect data associated with a call quality, and wherein the indirect data comprises data that does not include user communication content including voice signals.

50. The method of claim 45, further comprising:
rendering of a graphical user interface element on the first user device, wherein the graphical user interface element comprises a permission request; and
receiving a selection indication associated with the graphical user interface element of acceptance of the permission request, wherein the user device data object is generated in an instance in which the permission request is accepted.

51. The method of claim 50, wherein the permission request comprises a request for enhanced permissions for the software application.

52.-160. (canceled)
